(19) United States
(12) Patent Application Publication
(10) Pub. No.: US 2025/0265076 A1
(43) Pub. Date: Aug. 21, 2025

(54) METHOD AND APPARATUS FOR DESIGNING AND ENFORCING A MULTI-CLOUD DEPLOYMENT POLICY FOR SOFTWARE APPLICATIONS

(71) Applicant: Calibo LLC, Miami, FL (US)

(72) Inventor: Raj Vattikutti, Bloomfield Hills, MI (US)

(21) Appl. No.: 19/058,817

(22) Filed: Feb. 20, 2025

Related U.S. Application Data
(60) Provisional application No. 63/555,455, filed on Feb. 20, 2024.

(51) Int. Cl. G06F 8/70; G06F 8/34; G06F 8/35

(52) U.S. Cl. CPC G06F 8/70; G06F 8/34; G06F 8/35

(57) ABSTRACT

Provided is an architecture for facilitating creation and enforcement of policy templates. The architecture includes a policy template designer, a script generator, a policy enforcement engine, and a plurality of technology-specific interpreters. The policy template designer records, for creating a policy template, selection of a set of technologies. The script generator generates a policy template script indicative the set of technologies. The policy enforcement engine generates a set of provisioning scripts indicative of a set of resources to be provisioned by the set of technologies. The policy enforcement engine communicates the set of provisioning scripts to a set of technology-specific interpreters of the plurality of technology-specific interpreters. The set of technology-specific interpreters communicate with the set of technologies to provision the set of resources.

### CROSS-REFERENCE TO RELATED APPLICATIONS/INCORPORATION BY REFERENCE

This patent application makes reference to, claims priority to, and claims the benefit of U.S. provisional application 63/555,455 filed Feb. 20, 2024, the contents of which is hereby incorporated herein by reference in its entirety.

### FIELD

Various embodiments of the disclosure relate to cloud-based development and deployment of software products. More particularly, various embodiments of the disclosure relate to methods and apparatus for creation and enforcement of policy templates for cloud-based development and deployment of software products.

### BACKGROUND

In the modern software development ecosystem, the lifecycle of a software product involves various stages, such as requirements gathering, design, development, testing, deployment, and maintenance. Each of these stages requires specific tools, technologies, and configurations to ensure efficient execution and delivery. Over the years, several platforms have been developed to provide a unified interface for managing and executing these stages, aiming to streamline processes and simplify the integration of disparate tools and technologies.

However, the selection of tools, technologies, and configurations within these platforms remains a significant challenge. Each stage of the lifecycle presents numerous options, each with its own features, compatibilities, and configurations. The selection process may be influenced by a range of factors, including organizational preferences, software requirements, compliance policies, compatibility constraints, and other dynamic considerations. This complexity increases the risk of errors in the selection process, leading to inefficiencies, delays, or even failures in the software lifecycle. Furthermore, the manual nature of the selection process is highly prone to human error and non-standardized, resulting in incorrect or inconsistent choices that can negatively impact the overall development process.

Traditionally, organizations rely on static documentation to support the selection process, detailing organizational preferences, requirements, compliance policies, and compatibility guidelines. While these documents provide guidance, they are often insufficient to address the dynamic and evolving nature of various stages (for example, define stage, design stage, development stage, and deployment stage) of modern software development lifecycle. Organizational preferences, requirements, and compliance policies frequently change due to market trends, technological advancements, and regulatory updates. As a result, static documentation becomes outdated quickly, leading to suboptimal decisions and errors. Moreover, manually referencing and applying this documentation at every stage of the lifecycle is cumbersome, time-consuming, and further prone to human error. This challenge is especially pronounced in large-scale or enterprise environments, where the sheer number of tools, technologies, and configurations, combined with their complex interactions, makes manual processes inadequate.

In light of the foregoing, there is a need for a technical solution that overcomes the abovementioned problems.

### SUMMARY

An apparatus and a method for creation and enforcement of policy templates for executing various stages (for example, a development stage and a deployment stage) of the software development lifecycle (SDLC) is provided substantially as shown in, and/or described in connection with, at least one of the figures, as set forth more completely in the claims.

In an embodiment of the present disclosure, a non-transitory computer-readable medium is disclosed. The non-transitory computer-readable medium has computer executable instructions stored therein, which when executed by a computer, implement an architecture for creation and enforcement of policy templates. The architecture comprises a policy template designer, a script generator, a policy enforcement engine, and a plurality of technology-specific interpreters. A policy template designer configured to record a first plurality of user actions performed on a user interface (UI) for creation of a policy template for one or more software development lifecycle (SDLC) stages (for example, define stage, design stage, development stage, and deployment stage) of a software product. The first plurality of user actions include selection of a first set of technologies of a plurality of technologies available for execution of a set of stage specific operations of the one or more SDLC stages. The first set of technologies is selected for execution of the set of stage specific operations of each of the one or more SDLC stages. The script generator is configured to generate, based on the first plurality of user actions, a policy template script indicative of the first set of technologies selected for execution of the set of stage specific operations of each of the one or more SDLC stages. The policy enforcement engine is configured to generate, based on the policy template script, a set of provisioning scripts indicative of a set of resources to be provisioned by the first set of technologies. The policy enforcement engine is further configured to communicate the set of provisioning scripts to a first set of technology-specific interpreters of the plurality of technology-specific interpreters. The first set of technology-specific interpreters is configured to receive the set of provisioning scripts from the policy template scripts. The first set of technology-specific interpreters is further configured to communicate, based on the received set of provisioning scripts, with the first set of technologies to provision the set of resources for execution of the set of stage specific operations of the one or more SDLC stages.

In another embodiment, a method for creating and enforcing policy templates is disclosed. The method comprising recording a first plurality of user actions performed on a user interface (UI) for creation of a policy template for one or more SDLC stages of a software product. The first plurality of user actions include selection of a first set of technologies of a plurality of technologies available for execution of a set of stage specific operations of the one or more SDLC stages. The first set of technologies is selected for execution of the set of stage specific operations of each of the one or more SDLC stages. The method further comprising generating, based on the first plurality of user actions, a policy template script indicative of the first set of technologies selected for execution of the set of stage specific operations of each of the one or more SDLC stages. The method further comprising generating, based on the policy template script, a set of provisioning scripts indicative of a set of resources to be provisioned by the first set of technologies. The method further comprising communicating, based on the set of provisioning scripts, with the first set of technologies to provision the set of resources for execution of the set of stage specific operations of each of the one or more SDLC stages.

In yet another embodiment, the policy template script comprises at least one of a group consisting of: an application topology subscript, a deployment standards subscript, a pipeline configuration subscript, a cloud environment subscript, or an access policy subscript.

In some embodiments, the provisioning of the set of resources by each of the first set of technologies corresponds to the enforcement of the policy template script.

In some embodiments, the policy template designer is further configured to render, on a user device, the UI for the creation and enforcement of the policy templates. The UI represents a plurality of SDLC stages of the software product. Each of the plurality of SDLC stages is associated with a set of stage specific operations. The policy template designer is further configured to present, using the UI, the plurality of technologies. The plurality of technologies is presented based on a selection of the one or more SDLC stages of the plurality of SDLC stages. The first plurality of user actions is recorded further based on the presented plurality of technologies.

In some embodiments, the first set of technology-specific interpreters is further configured to convert the set of provisioning scripts into a set of technology-specific scripts that is in a format that is compatible with the first set of technologies. The first set of technology-specific interpreters is further configured to communicate the set of technology-specific scripts to the first set of technologies. The first set of technologies receives the set of provisioning scripts and provisions, based on the received set of technology-specific scripts, the set of resources.

In some embodiments, the architecture further comprises a plurality of gentech script generators. A set of gentech script generators of the plurality of gentech script generators is configured to generate, based on the policy template script, a set of gentech scripts for implementing the provisioning of the set of resources by the first set of technologies. The set of gentech script generators is compatible with the first set of technologies. The first set of technology-specific interpreters communicates with the first set of technologies further based on the set of gentech scripts.

In some embodiments, the one or more SDLC stages comprise at least one of a group consisting of a define stage, a design stage, a development stage, or a deployment stage.

In some embodiments, the architecture further comprising a plurality of reverse interpreters. A set of reverse interpreters of the plurality of reverse interpreters is configured to receive a set of feedback scripts from the first set of technologies. The script generator is further configured to generate an updated policy template script based on the set of feedback scripts.

In some embodiments, the policy enforcement engine is further configured to update the set of provisioning scripts based on the updated policy template script. The first set of technology-specific interpreters is further configured to communicate with the first set of technologies further based on the updated provisioning script.

In some embodiments, the set of feedback scripts is received based on an execution of the one or more SDLC stages.

In some embodiments, the architecture further comprises a set of predefined policy template scripts with each predefined policy template script of the set of predefined policy template scripts being indicative of a corresponding second set of technologies for execution of a set of stage specific operations of the one or more SDLC stages.

In some embodiments, the policy enforcement engine is further configured to generate, based on at least one of the set of predefined policy template scripts, a predefined provisioning script. A second set of technology-specific interpreters of the plurality of technology-specific interpreters are configured to communicate with the second set of technologies, based on the predefined provisioning script, to provision one or more resources based on the predefined provisioning script.

In some embodiments, the policy template designer is further configured to record a second plurality of user actions performed on the UI for modification of the policy template. The second plurality of user actions include selection of a second set of technologies of the plurality of technologies for execution of one or more stage specific operations of the set of stage specific operations of the one or more SDLC stages. The script generator is further configured to update, based on the second plurality of user actions, the policy template script to reflect the selection of the second set of technologies. The policy enforcement engine is further configured to generate, based on the updated policy template script, a set of revised provisioning scripts that conforms with the updated policy template script. The policy enforcement engine is further configured to communicate the set of revised provisioning scripts to a second set of technology-specific interpreters of the plurality of technology-specific interpreters. The set of revised provisioning scripts is indicative of a change in the set of resources. The second set of technology-specific interpreters is configured to communicate, based on the set of revised provisioning scripts, with the second set of technologies to update the set of resources provisioned for execution of the set of stage specific operations.

In some embodiments, the policy template script is generated further based on at least one of a group consisting of a set of application driven policies or a set of optimal policy practices.

In some embodiments, the policy enforcement engine comprises a validation engine configured to execute, using the policy template script, one or more SDLC stages of a demo software product with a software configuration of the software product. The validation engine is further configured to generate, based on the execution of the one or more SDLC stages of the demo software product, a set of updates for the policy template script. The validation engine is further configured to validate, based on the execution of the one or more SDLC stages of the demo software product, the policy template script. The validation of the policy template script is indicative of the policy template being implementable using the first set of technologies.

In some embodiments, the set of provisioning scripts includes at least one of a group consisting of: an environment policy script, an access provisioning script, or a pipeline orchestration script.

In some embodiments, the policy enforcement engine further comprises a cloud environment provisioning engine configured to generate the environment policy script, a user access provisioning engine configured to generate an access policy script, and a pipeline setup engine configured to generate a pipeline configuration script. The environment policy script includes a first set of instructions indicative of provisioning of a first subset of resources, of the set of resources, to be provisioned for creation of a cloud environment for the software product. The access policy script includes a second set of instructions indicative of provisioning of a second subset of resources, of the set of resources, to be provisioned for implementing access control policy associated with the software product. The pipeline orchestration script includes a third set of instructions indicative of a third subset of resources, of the set of resources, to be provisioned for creation of one or more pipeline stages associated with the software product. The first subset of resources, the second subset of resources, and the third subset of resources, collectively, constitute the set of resources.

In some embodiments, the environment policy script is further indicative of a first subset of technologies of the first set of technologies selected for provisioning of the first subset of resources. The access policy script is further indicative of a second subset of technologies of the first set of technologies selected for provisioning of the second subset of resources. The pipeline orchestration script is further indicative of a third subset of technologies of the first set of technologies selected for provisioning of the third subset of resources. The first subset of technologies, the second subset of technologies, and the third subset of technologies, collectively, constitute the first set of technologies.

In some embodiments, the architecture further comprising a watcher configured to monitor the creation and enforcement of the policy template. The provisioning of the set of resources corresponds to the enforcement of the policy template. The watcher is further configured to analyse the enforced policy template based on at least one of a group consisting of the provisioned set of resources or an execution of the set of stage specific operations of the one or more SDLC stages. The watcher is further configured to generate a set of recommendations associated with the enforced policy template. The set of recommendations is generated based on the set of provisioned resources being divergent from a set of required resources for the execution of the set of stage specific operations of the one or more SDLC stages of the software product.

These and other features and advantages of the present disclosure may be appreciated from a review of the following detailed description of the present disclosure, along with the accompanying figures in which like reference numerals refer to like parts throughout.

### BRIEF DESCRIPTION OF THE DRAWINGS

The accompanying drawings illustrate the various embodiments of systems, methods, and other aspects of the disclosure. It will be apparent to a person skilled in the art that the illustrated element boundaries (e.g., boxes, groups of boxes, or other shapes) in the figures represent one example of the boundaries. In some examples, one element may be designed as multiple elements, or multiple elements may be designed as one element. In some examples, an element shown as an internal component of one element may be implemented as an external component in another, and vice versa.

Various embodiments of the present disclosure are illustrated by way of example, and not limited by the appended figures, in which like references indicate similar elements, and in which:

FIG. 1 is a block diagram that illustrates a system environment for managing technologies to facilitate definition, design, development, and deployment of a software product, in accordance with an embodiment of the present disclosure;

FIG. 2 is a block diagrams that illustrates a primary architecture of a service application of the system environment of FIG. 1, in accordance with an embodiment of the present disclosure;

FIG. 3 is a block diagram that illustrates a detailed architecture of the service application of the system environment of FIG. 1, in accordance with another embodiment of the present disclosure;

FIG. 4 is a block diagram that illustrates different stages of creation and enforcement of a policy template for execution of a development stage and a deployment stage of a software product, in accordance with an embodiment of the present disclosure;

FIGS. 5A-5E, collectively, represent a block diagram that depicts a process workflow for creation and enforcement of a policy template using the primary architecture, in accordance with an embodiment of the present disclosure;

FIGS. 6A and 6B, collectively, illustrate a block diagram for enforcing a policy template for a software product, in accordance with an embodiment of the present disclosure;

FIGS. 7A-7C, collectively, illustrate an exemplary user interface that enables creation, compilation, and enforcement of the policy templates, in accordance with an embodiment of the present disclosure;

FIG. 8 is a block diagram that illustrates a system architecture of a computer system for designing and enforcing a multi-cloud deployment policy for software application of the system environment of FIG. 1, in accordance with an exemplary embodiment of the disclosure; and

FIG. 9 is a flowchart that illustrates a method for creation and enforcement of a policy template, in accordance with an embodiment of the present disclosure.

Further areas of applicability of the present disclosure will become apparent from the detailed description provided hereinafter. It should be understood that the detailed description of exemplary embodiments is intended for illustration purposes only and is, therefore, not intended to necessarily limit the scope of the present disclosure.

### DETAILED DESCRIPTION

The present disclosure is best understood with reference to the detailed figures and description set forth herein. Various embodiments are discussed below with reference to the figures. However, those skilled in the art will readily appreciate that the detailed descriptions given herein with respect to the figures are simply for explanatory purposes as the methods and systems may extend beyond the described embodiments. In one example, the teachings presented and the needs of a particular application may yield multiple alternate and suitable approaches to implement the functionality of any detail described herein. Therefore, any approach may extend beyond the particular implementation choices in the following embodiments that are described and shown.

References to “an embodiment”, “another embodiment”, “yet another embodiment”, “one example”, “another example”, “yet another example”, “for example”, and so on, indicate that the embodiment(s) or example(s) so described may include a particular feature, structure, characteristic, property, element, or limitation, but that not every embodiment or example necessarily includes that particular feature, structure, characteristic, property, element or limitation. Furthermore, repeated use of the phrase “in an embodiment” does not necessarily refer to the same embodiment.

Various embodiments of the present disclosure disclose an architecture for facilitating creation and enforcement of policy templates. The architecture includes a policy template designer, a script generator, a policy enforcement engine, and a plurality of technology-specific interpreters. The policy template designer records, for creating a policy template, a plurality of user actions for selection of a set of technologies for executing a plurality of stage specific operations of one or more SDLC stages of a software product. Based on the selection, the script generator generates a policy template script indicative of the set of technologies. The policy enforcement engine generates a set of provisioning scripts indicative of a set of resources to be provisioned by the set of technologies. The policy enforcement engine communicates a set of provisioning scripts to a set of technology-specific interpreters of the plurality of technology-specific interpreters. The set of provisioning scripts is indicative of the set of resources to be provisioned for enforcing the policy template. The first set of technology-specific interpreters communicates with the set of technologies to provision the set of resources. The present disclosure addresses various complexities associated with creation and enforcement of policy templates based on static documentation that include various constraints, preferences, configurations, permissions, compliances, or the like that are to be adhered to while developing and deploying a software product.

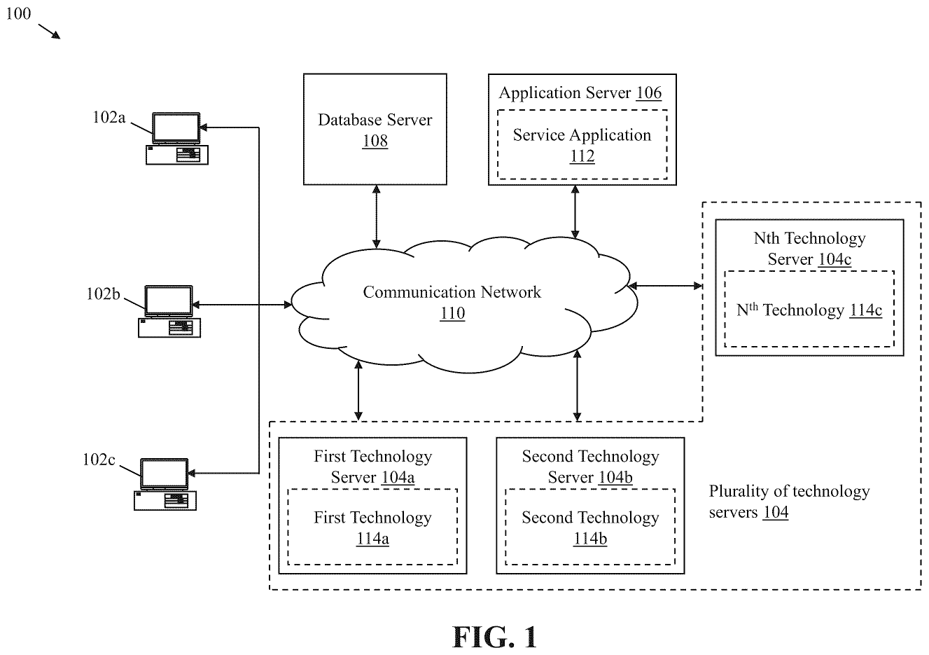

FIG. 1 is a block diagram that illustrates a system environment 100 for managing technologies to facilitate definition, design, development, and deployment of a software product, in accordance with an embodiment of the present disclosure. The system environment 100 is shown to include a plurality of user devices 102 (e.g., first through third user devices 102a-102c) and a plurality of technology servers 104 (e.g., first through nth technology servers 104a-104n). The system environment 100 is further shown to include an application server 106, a database server 108, and a communication network 110. The plurality of user devices 102, the plurality of technology servers 104, the application server 106, and the database server 108 may communicate with each other by way of the communication network 110.

The first user device 102a may include suitable logic, circuitry, interfaces and/or code, executable by the circuitry, that may be configured to execute one or more instructions based on user input received from a corresponding user. The first user device 102a may be further configured to execute a service application 112 that is hosted by the application server 106. In one embodiment, the service application 112 may be a standalone application installed on the first user device 102a. In another embodiment, the service application 112 may be accessible by way of a web browser installed on the first user device 102a. Examples of the first user device 102a may include, but are not limited to, a personal computer, a laptop, a smartphone, a tablet, or the like. The second and third user devices 102b and 102c may be functionally similar to the first user device 102a.

In one embodiment, the plurality of user devices 102 may be operated by a corresponding plurality of users associated with an organization. Examples of the organization include, but are not limited to, businesses, governments, non-profit organizations, or the like. In a non-limiting example, the organization may intend to develop a software product (e.g., a software application). The plurality of users may utilize the plurality of user devices 102 for definition, design, development, deployment, operation, monitoring, and/or maintenance of the software product. Examples of the software product may include software applications such as, but not limited to, e-commerce applications, video streaming applications, productivity applications, e-learning applications, or the like. It will be apparent to those of skill in the art that examples of the software product are not limited to those mentioned above. In an actual implementation, the software product may include any enterprise or consumer software application.

The first technology server 104a may include suitable logic, circuitry, interfaces, and/or code, executable by the circuitry, that may be configured to host a first technology 114a. In one embodiment, the first technology 114a may be one of a plurality of technologies available for designing, developing, deploying, maintaining, or monitoring the software product. In other words, the first technology 114a may be a technology or tool that is available for the design, development, deployment, security, operation, maintenance, or monitoring of the software product. In another embodiment, the first technology 114a may be a technology or tool that facilitates various operations pertaining to data analysis such as, but not limited to, data sourcing, data ingestion, data storage, data analysis, or data visualization. The first technology 114a may correspond to one of a software-as-a-service (SaaS), a platform-as-a-service (PaaS), or an infrastructure-as-a-service (IaaS). The first technology 114a may correspond to any technology that may be required by the organization at any phase or stage during a software development lifecycle (SDLC) or a data analytics/data science life cycle (DALC/DSLC) of the software product. For the sake of brevity, the terms “DALC” and “DSLC” are interchangeably used throughout the disclosure. In other words, the first technology 114a may include any application required for facilitating definition, design, development, or deployment of the software product. For the sake of brevity, the terms “software product”, “product”, and “software application” are used interchangeably throughout the entire disclosure.

For example, the first technology 114a may include a technology for requirement analysis, a technology for planning or project management, a technology for software architectural design. The first technology 114a may further include a technology for software development, a technology for software testing, a technology for software deployment, a technology for software maintenance, or a technology for document management. The first technology 114a may further include a technology for data storage (e.g., cloud data storage), a technology for data sourcing, a technology for data analytics, a technology for data visualization, or the like.

Throughout the disclosure, the terms “technology”, “technology service”, “technology platform”, or “tool” are used interchangeably. Technologies available for various stages or phases of the SDLC or the DALC of the software product may be well known to those of skill in the art. Examples of the first technology 114a may include, but are not limited to, Microsoft Azure®, Amazon web services (AWS®), Snowflake®, Jira®, or the like.

The first technology server 104a may be implemented by one or more processors, such as, but not limited to, an application-specific integrated circuit (ASIC) processor, a reduced instruction set computing (RISC) processor, a complex instruction set computing (CISC) processor, and a field-programmable gate array (FPGA) processor. The one or more processors may also correspond to central processing units (CPUs), graphics processing units (GPUs), network processing units (NPUs), digital signal processors (DSPs), or the like. It will be apparent to a person of ordinary skill in the art that the first technology server 104a may be compatible with multiple operating systems.

The second through nth technology servers 104b-104n may be functionally similar to the first technology server 104a. The second through nth technology servers 104b-104n may host the second through nth technologies 114b-114n, respectively. The second through nth technology servers 104b-104n may each correspond to any technology that is required for facilitating with the SDLC or the DALC of the software product. Hereinafter, for the sake of brevity, the first through nth technologies 114a-114n are designated and referred to as “first plurality of technologies 114”.

The application server 106 may include suitable logic, circuitry, interfaces, and/or code, executable by the circuitry, that may be configured to host the service application 112. The service application 112 hosted by the application server 106 may be an open pro-code PaaS that enables end-to-end definition, design, development, deployment, operation, and maintenance of the software product. The application server 106 is configured to enable, for the plurality of user devices 102 associated with the plurality of users, access to features provided by the service application 112. The application server 106 is configured to provide a single platform to various stakeholders (e.g., business partners, developers, product designers, management, or the like) to collaborate at various stages of development of the software product. The open pro-code PaaS may enable the organization to select technologies (e.g., the first plurality of technologies 114) for the design, development, deployment, operation, and maintenance of the software product, based on requirements/choices of the organization. In other words, the application server 106 enables, by way of the service application 112, selection/creation of a technology stack required for the SDLC and/or the DALC of the software product. Upgrades and licenses for the selected technologies may be managed by the application server 106. Each of the first plurality of technologies 114 may be one of a third-party technology or a proprietary technology. In a non-limiting example, a proprietary technology may be a technology that is associated with an entity that manages or owns the application server 106 (e.g., the service application 112). In such a scenario, the proprietary technology (e.g., technology platform) may be hosted/executed by the application server 106 itself or by a different server (e.g., one of the plurality of technology servers 104).

A technology stack may refer to a set of programming languages (e.g., Java, Swift, Scala, or Python), frameworks (e.g., Ruby on Rails, Django, Databricks, Hadoop, MLFlow, or Bootstrap), and/or technologies (e.g., tools or technology platforms for development, continuous integration-continuous deployment, data analytics, or the like) that are required for the SDLC and/or the DALC of the software product. In a non-limiting example, the technology stack for the SDLC of the software product may include a client-side component (e.g., frontend) and a server-side component (e.g., backend). The client-side component may include a frontend framework (e.g., AngularJS, React, jQuery, or the like). The server-side component may include a backend framework (e.g., Ruby on Rails, Django, or .Net), operating systems (e.g., Linux, Android, or iOS), programming languages (e.g., Java, Ruby, Python), and/or infrastructure and load balancing tools (e.g., AWS, Microsoft Azure, Cloudflare, or Apache). The server-side component may further include data storage and querying tools (e.g., MongoDB, RedShift, Snowflake, or MySQL) and monitoring and performance tools (e.g., AppDynamics, Dynatrace, or Datadog).

The technology stack may further include tools or applications for business intelligence (BI), application programming interface (API) services, product analytics, or the like. Examples of the tools/applications for BI include, but are not limited to, SAP BusinessObjects, Tableau, Looker, Microsoft Power BI, or the like. Examples of the tools/applications for API services include, but are not limited to, Segment, Google Apigee, Zapier, or the like. Examples of the tools/applications for product analytics may include, but are not limited to, Heap, Countly, Mixpanel, or the like. The technology stack may further include other tools or applications for version control (e.g., GitHub, Gitlab, or AWS CodeCommit), continuous integration/continuous deployment (e.g., Jenkins, Bamboo, or Codeship), testing (e.g., Selenium, TestingWhiz, or TestComplete), or the like. Selection of the technology stack is well known to those of skill in the art.

The application server 106 enables integration and orchestration of services provided by the various technologies (e.g., the first plurality of technologies 114) of the technology stack. The technology stack may include PaaS, SaaS, IaaS technologies/applications provided by various technologies such as, AWS, Microsoft Azure, Snowflake, Jira, R studio, Databricks, GitHub, or the like. Examples of the application server 106 may include a cloud-based server, a local server, a group of centralized servers, a group of distributed servers, or the like.

The application server 106 may facilitate, for the plurality of user devices 102, access to various technologies (e.g., technology platforms) by way of the service application 112. In an example, the organization may use Databricks for ingesting data from a data source, and Snowflake for storage of the ingested data. Similarly, the application server 106 may enable configuration of Databricks and Snowflake via the service application 112. Details of one or more services provided by the service application 112 hosted by the application server 106 are described later in the disclosure.

In an embodiment, the application server 106 may communicate with the plurality of technology servers 104 associated with corresponding technologies to enable each user device, of the plurality of user devices 102, to access one or more services provided by said technologies. In another embodiment, multiple technologies may be hosted on a single platform server (e.g., the first technology server 104a). In such a scenario, the application server 106 may communicate with the first technology server 104a to enable each of the plurality of user devices 102 to access one or more services provided by said technologies.

The application server 106 may be implemented by one or more processors, such as, but not limited to, an ASIC processor, a RISC processor, a CISC processor, and an FPGA processor. The one or more processors may also correspond to CPUs, GPUs, NPUs, DSPs, or the like. It will be apparent to a person of ordinary skill in the art that the application server 106 may be compatible with multiple operating systems.

The database server 108 may include suitable logic, circuitry, interfaces, and/or code, executable by the circuitry, that may be configured to store data and perform one or more database operations associated with the stored data. Examples of the database operations may include, but are not limited to, receiving, storing, processing, and transmitting data pertaining to a use of the service application 112 by the plurality of users. The database server 108 may further receive, store, process, and transmit data associated with the plurality of users. In an embodiment, the database server 108 may be further configured to receive, store, process, and transmit data associated with usage of the plurality of user devices 102 by the plurality of users. The database server 108 may include a database such as, but not limited to, Hadoop®, MongoDB®, MySQL®, NoSQL®, and Oracle®, or the like.

Examples of the database server 108 may include, but are not limited to, a personal computer, a laptop, a mini-computer, a mainframe computer, a cloud-based server, a network of computer systems, or a non-transient and tangible machine executing a machine-readable code. For the sake of brevity, the application server 106 and the database server 108 have been shown as separate systems. However, in some embodiments, the database server 108 may be integrated within the application server 106. In such scenarios, functions performed by the database server 108 may be performed by the application server 106 without deviating from the scope of the disclosure.

The communication network 110 may include suitable logic, circuitry, interfaces, and/or code, executable by the circuitry, that is configured to facilitate communication among various entities (such as the plurality of user devices 102, the plurality of technology servers 104, the application server 106, and the database server 108) described in FIG. 1. Examples of the communication network 110 may include, but are not limited to, a wireless fidelity (Wi-Fi) network, a light fidelity (Li-Fi) network, a local area network (LAN), a wide area network (WAN), a metropolitan area network (MAN), a satellite network, the Internet, a fiber optic network, a coaxial cable network, an infrared (IR) network, a radio frequency (RF) network, and a combination thereof. Various entities (such as the plurality of user devices 102, the plurality of technology servers 104, the application server 106, and the database server 108) in the system environment 100 may be communicatively coupled to the communication network 110 in accordance with various wired and wireless communication protocols, such as Transmission Control Protocol and Internet Protocol (TCP/IP), User Datagram Protocol (UDP), Long Term Evolution (LTE) communication protocols, or any combination thereof.

It will be apparent to a person skilled in the art that the system environment 100 described in conjunction with FIG. 1 is exemplary and does not limit the scope of the disclosure. In other embodiments, the system environment 100 may include different or additional components configured to perform similar or additional operations.

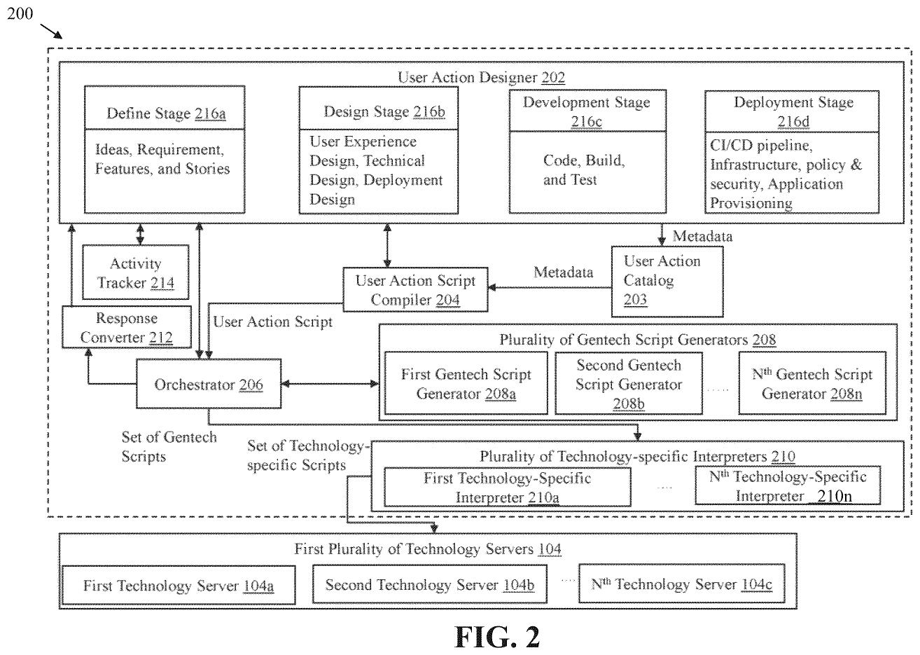

FIG. 2 is a block diagram that illustrates a primary architecture 200 of the service application 112 of the system environment of FIG. 1, in accordance with an embodiment of the present disclosure. For the sake of brevity, the primary architecture 200 of the service application 112 is simply referred to as “architecture 200” throughout the disclosure.

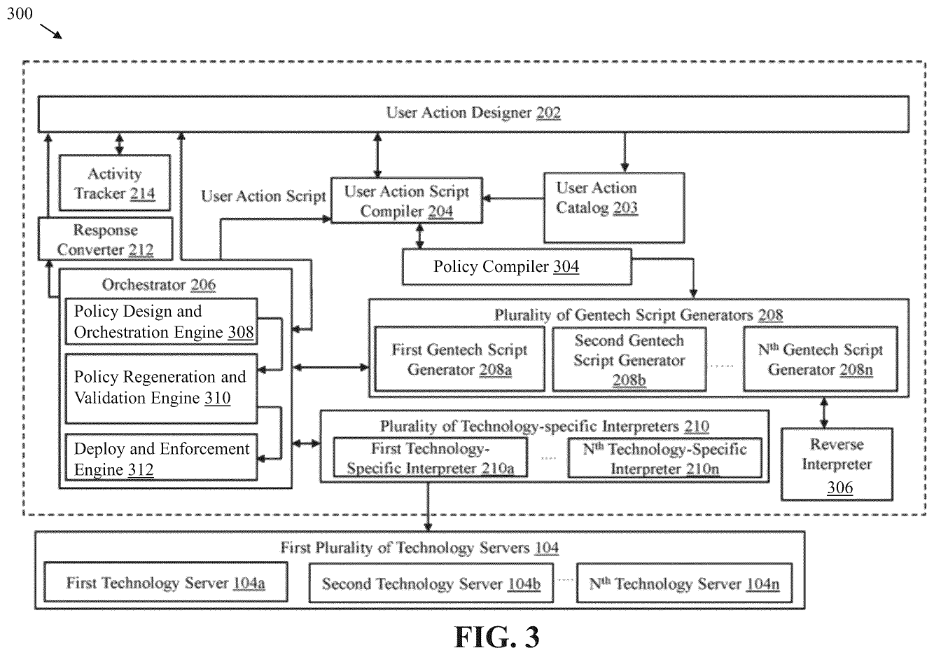

The architecture 200 is shown to include a user action designer 202, a user action catalog 203, a user action script compiler 204, an orchestrator 206, first through nth gentech script generators 208a-208n, first through nth technology-specific interpreters 210a-210n, and a response converter 212. The first through nth gentech script generators 208a-208n are collectively designated and referred to as “plurality of gentech script generators 208”, and the first through nth technology-specific interpreters 210a-210n are referred to as “plurality of technology-specific interpreters 210”. The architecture 200 of the service application 112 is further shown to include an activity tracker 214. The architecture 200 of the service application 112 may further include a product orchestration designer. However, the product orchestration designer is not shown in FIGS. 2 and 3 in order to not obscure the disclosure. The service application 112 enables implementation of generation of policy templates for various stages of product development for the software application. The various stages of product development may include, but are not limited to, a define stage, a design stage, a development stage, and a deployment stage.

The user action designer 202 renders, on a user device (e.g., the first user device 102a), a UI (user interface) that presents the first plurality of technologies 114 available for facilitating (e.g., generating or deploying) deployment of the plurality of deployment policies during the product development of the software application. Examples of the plurality of technologies may include, but are not limited to, technologies for project management, technology for version control or repository management (e.g., code commits), technologies for SAST, or technologies for DAST (dynamic application security testing). Examples of the first plurality of technologies 114 may further include technologies for CI/CD pipeline automation (e.g., orchestration), technologies for infrastructure provisioning, technologies for cloud deployment, or technologies for monitoring of the software application after deployment of the software application.

Examples of the first plurality of technologies 114 may further include technologies for data ingestion, technologies for data warehousing or data storage, technologies for data analytics, or technologies for data visualization. In other words, the UI rendered by the user action designer 202 presents multiple technologies (e.g., tens, hundreds, or thousands of technologies) available for performing various sets of operations (e.g., code commit, continuous integration, project management, data analytics, or the like) associated with the plurality of stages 216. The first plurality of technologies 114 are available for performing a first plurality of operations associated with the plurality of stages 216. The first plurality of operations may include any operation associated with the define stage 216a, the design stage 216b, the development stage 216c, or the deployment stage 216d. Further, the first plurality of operations may include any operation that is required for generating deployment policies during the product definition stage, development stage, and the deployment stage of the software application.

Each of the first plurality of technologies 114 may be available for performing one or more operations of the first plurality of operations. For example, a first technology of the first plurality of technologies 114 may be available for performing or facilitating project management (e.g., agile project management) for the product development of the software application. In other words, the first technology of the first plurality of technologies 114 may be available for implementing the define stage 216a for the product development of the software application. In another example, a second technology of the first plurality of technologies 114 may be available for implementing multiple stages (e.g., performing multiple operations) in a data pipeline associated with the software application. Each of the first plurality of operations may be associated with multiple technologies available for performing a corresponding operation. For example, a first operation (e.g., repository management) may be executed by a second plurality of technologies included in the first plurality of technologies 114. In other words, the second plurality of technologies that are available for executing (e.g., performing) the first operation are a subset of the first plurality of technologies 114. Similarly, a second operation (e.g., cloud deployment) may be associated with a third plurality of technologies included in the first plurality of technologies 114. The UI rendered on the first user device 102a may be indicative of the first plurality of technologies 114 and the first plurality of operations available for facilitating generating and enforcing plurality of deployment policies during plurality of stages 216. In one embodiment, a first technology for performing an operation associated with the plurality of stages 216 may be selected by the user by way of the rendered UI. In other embodiment, one or more operations required for implementing one or more stages of the plurality of stages 216 may be selected by the user by way of the rendered UI. For the sake of brevity, it is assumed that a first set of operations of the first plurality of operations is selected by the user. The workflow may include various operations or sub-operations that are to be executed for completion of an execution of the first set of operations.

The user action designer 202 may determine, based on the selection of the first set of operations and the first plurality of technologies 114, a second plurality of technologies available for executing the first set of operations. The second plurality of technologies is a subset of the first plurality of technologies. In other words, the first plurality of technologies include the second plurality of technologies. In an example, consider a cloud-based infrastructure management platform that leverages the provided data to deploy policy templates through a user interface (UI) on the first user device 102a. The UI displays a plurality of technologies 114 and operations associated with different stages of deployment 216. A system administrator, using the rendered UI, selects a set of operations, representing a specific deployment policy template. This template may include operations related to provisioning, scaling, and monitoring resources during various stages of application deployment. The selected operations and associated technologies form the first set of operations within the first plurality. The platform's deployment orchestrator then translates this selection into a deployment policy template, capturing the sequence of operations and the corresponding technologies required. Subsequently, this policy template is applied to the cloud infrastructure in real-time, automating the deployment process. The platform ensures that the defined operations are executed using the chosen technologies, providing a streamlined and standardized approach to deploying applications across multiple stages while enforcing the specified deployment policies.

The determination of the second plurality of technologies may be based on a look-up table (not shown) stored in the user action designer 202 or in a memory associated therewith. The look-up table may be indicative of a mapping between the first plurality of operations and the first plurality of technologies 114. In other words, the look-up table may be indicative of operations that may be performed by each technology of the first plurality of technologies 114. Similarly, the look-up table may be indicative of technologies, of the first plurality of technologies 114, available for performing each of the first plurality of operations.

Further, FIG. 2, based on the determination of the second plurality of technologies, the user action designer 202 may present the second plurality of technologies on the UI rendered on the first user device 102a. One or more technologies of the second plurality of technologies may be selected by the user for the execution of the first set of operations. In a non-limiting example, it is assumed that a first technology of the second plurality of technologies is selected by the user for the execution of the first set of operations. The user action designer 202 records (e.g., captures) a first plurality of user actions performed by the user on the UI. The first plurality of user actions include various user actions associated with the plurality of stages 216 (e.g., one of the plurality of stages 216) and performed by the user on the UI rendered on the first user device 102a. The user action designer 202 may generate, based on the recorded first plurality of user actions, metadata associated with the first plurality of user actions. The generated metadata may include, but is not limited to, the selection of the first set of operations, the selection of the first technology 114a of the second plurality of technologies, a set of execution parameters for the execution of the first set of operations, or the like. The set of execution parameters may refer to one or more parameters/parameter values provided (e.g., entered) by the user (e.g., the plurality of users) for the execution of the first set of operations. For example, consider an enterprise using a cloud management platform to deploy policy templates for their application infrastructure. The user action designer 202 captures a system administrator actions on the UI of their device 102a. The administrator, tasked with deploying a new application, selects a set of operations representing deployment stage, and specifies the use of a particular technology (e.g., first technology 114a). The user action designer records this information as metadata, including execution parameters provided by the user, such as resource allocation and scaling thresholds. The recorded user actions also involve the creation of a customized template, where the administrator inputs a name and description. Additionally, the administrator selects desired technologies for specific operations through the UI.

The user action designer 202 stores, in the user action catalog 203, the metadata associated with the first plurality of user actions. The user action catalog 203 provides the metadata as input to the user action script compiler 204. The user action script compiler 204 may generate, based on the metadata, a first set of user action scripts. The generated first set of user action scripts may include data, application program interfaces (APIs), code, database scripts, configuration files, or the like that correspond to the metadata. For example, consider a cloud infrastructure management platform where the user action designer 202) plays a crucial role in deploying policy templates. The platform employs a user action catalog 203 to store metadata associated with a series of user actions performed on the user interface by a system administrator. The user actions might involve the selection of deployment stages, technologies, and the provision of execution parameters. The stored metadata is then fed into the user action script compiler 204. The user action script compiler 204 processes the metadata and generates a first set of user action scripts. The user action scripts encompass a range of artifacts, such as data, APIs, code snippets, database scripts, and configuration files, aligning with the specific actions recorded by the user. Further, the compiled user action scripts become the executable instructions for the deployment process, ensuring that the defined policies are translated into actionable configurations, APIs, and scripts.

For the sake of brevity, it is assumed that the first set of user action scripts includes a single user action script (e.g., a first user action script). However, in another embodiment, the set of user action scripts may include multiple user action scripts. The first user action script is indicative of the selection of the first technology 114a and the selection of the first set of operations to be executed by the first technology 114a.

The first user action script may include multiple sections (e.g., a plurality of sections). A first section of the first user action script may correspond to the selected first technology 114a and may be indicative of the selection of the first technology 114a and the first set of operations to be executed by the first technology 114a. The first section of the first user action script may further be indicative of the execution parameters for the execution of the first set of operations.

The plurality of gentech script generators 208 include first through nth gentech script generators 208. Each gentech script generator, of the plurality of gentech script generators 208, is configured to generate, scripts that are in a technology-agnostic format. For the sake of brevity, scripts that are in a technology-agnostic format are interchangeably referred to as “gentech scripts” throughout the disclosure. Gentech scripts may be generated by the plurality of gentech script generators 208 based on user action scripts (e.g., the first set of user action scripts, the first user action script, or the like) or on sections of user action scripts (e.g., the first section of the first user action script). Each gentech script generator, of the plurality of gentech script generators 208, may be associated with an operation of the first plurality of operations. In other words, each gentech script generator, of the plurality of gentech script generators 208, is configured to generate gentech scripts for technology-specific interpreters associated with technologies (e.g., the second plurality of technologies) available for execution of a corresponding set of operations (e.g., data ingestion). For example, the first gentech script generator 208a may be associated with data ingestion (e.g., the first set of operations) and may be configured to generate gentech scripts for a plurality of technology-specific interpreters associated with the second plurality of technologies.

The gentech scripts generated by the first gentech script generator 208a may be technology-agnostic (e.g., in a technology-agnostic format) with respect to the plurality of technology-specific interpreters associated with the second plurality of technologies. Therefore, each gentech script generator, of the plurality of gentech script generators 208, is configured to cater to a class of technologies (e.g., the second plurality of technologies) that are available to execute a similar or same set of operations (e.g., the first set of operations). In a non-limiting example, it is assumed that a single gentech script generator caters to all technologies (e.g., technology platforms) that are included within a corresponding class of technologies. However, in another embodiment, there may be multiple gentech script generators, each configured to cater to one or more sub-classes of technologies within the class of technologies.

The plurality of technology-specific interpreters 210 include first through Nth technology-specific interpreters 210a-210n for the first plurality of technologies 114. Each of the first through nth technology-specific interpreters 210a-210n may be configured to generate technology-specific scripts for a corresponding technology of the first plurality of technologies 114. Each of the first through nth technology-specific interpreters 210a-210n may be configured to generate technology-specific scripts based on a set of gentech scripts received from a gentech script generator of the plurality of gentech script generators 208. In other words, each of the first through nth technology-specific interpreters 210a-210n may be configured to convert gentech scripts received from a corresponding gentech script generator to a technology-specific script that is compatible with a corresponding technology. For example, the first technology-specific interpreter 210a that is associated with the first technology 114a may be configured to convert gentech scripts received from the first gentech script generator 208a into corresponding technology-specific scripts. Similarly, the second technology-specific interpreter 210b that is associated with the second technology 114b may be configured to convert gentech scripts received from the first gentech script generator 208a into corresponding technology-specific scripts.

Based on the determination or identification that the first gentech script generator 208a is mapped to the first technology-specific interpreter 210a, the orchestrator 206 may communicate the second set of gentech scripts to the first gentech script generator 208a.

Each of the plurality of gentech script generators 208 may be further configured to generate user action scripts based on gentech scripts received from the plurality of technology-specific interpreters 210. In other words, each of the plurality of gentech script generators 208 may be further configured to convert the received gentech scripts into user action scripts. Based on the received second set of gentech scripts, the first gentech script generator 208a may generate a second set of user action scripts. The second set of user action scripts is indicative of the first progress data received from the first technology 114a. The first gentech script generator 208a may communicate the second user action script to the orchestrator 206. The orchestrator 206 may communicate the second user action script to the response converter 212.

The response converter 212 receives the second user action script from the orchestrator 206, and may generate, based on the second user action script, a first set of user action responses. The first set of user action responses may include metadata indicative of the first progress data. The user action designer 202 may receive the first set of user action response. Based on the first set of user action responses, the user action designer 202 may generate a first set of visual indicators and present the first set of visual indicators on the UI rendered on the first user device 102a. The first set of visual indicators may include, but is not limited to, text, numbers, or diagrams (e.g., diagrammatic elements) indicative of the first progress data. For example, the first set of visual indicators may include the generated set of documents or a link to the generated set of documents, alert messages (e.g., text) or logs (e.g., text) indicative of the progress of the execution of the first set of operations. Similarly, the first set of visual indicators may further include the level of completion (e.g., numbers) of the execution of the first set of operations. Similarly, the first set of visual indicators may further include diagrammatic representations (e.g., graphs, charts, scatter plots, tables, or the like) indicative of the first progress data.

It is assumed that each of the first plurality of technologies 114 is associated with a technology-specific interpreter of the plurality of technology-specific interpreters 210. In other words, each technology communicates with a corresponding technology-specific interpreter of the plurality of technology-specific interpreters 210. However, in another embodiment, the architecture 200 of the service application 112 may include a single technology-specific interpreter, in lieu of the plurality of technology-specific interpreters 210. In such a scenario, the single technology-specific interpreter (not shown) may communicate with the first plurality of technologies 114.

The orchestrator 206 may store, therein, or in a memory associated therewith a second look-up table (not shown). The second look-up table may be indicative of a mapping between the first plurality of technologies, the plurality of gentech script generators 208, and the plurality of technology-specific interpreters 210.

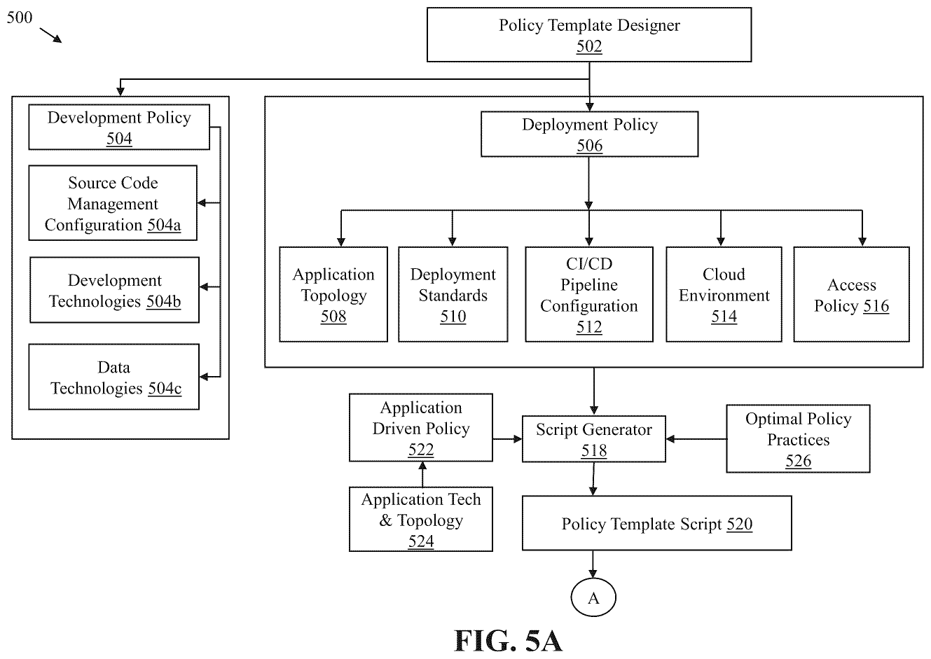

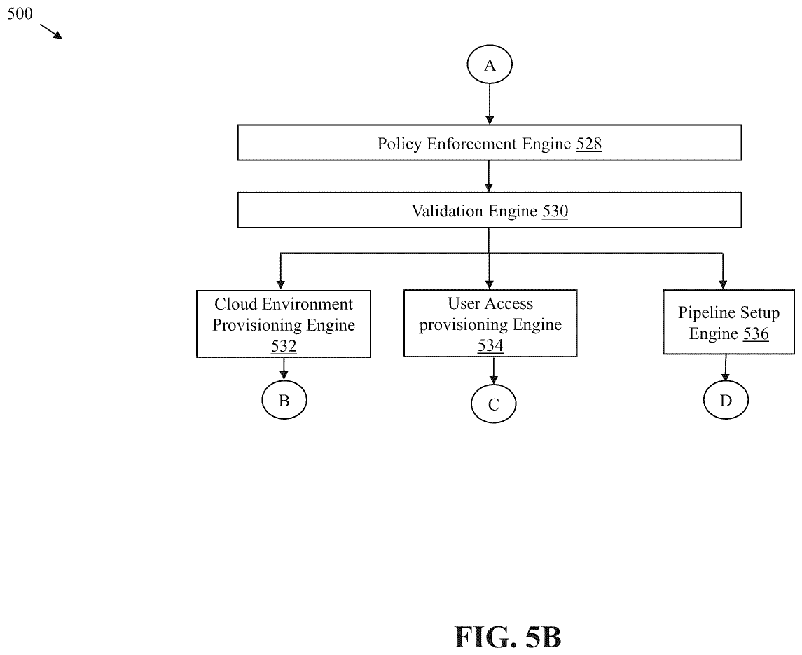

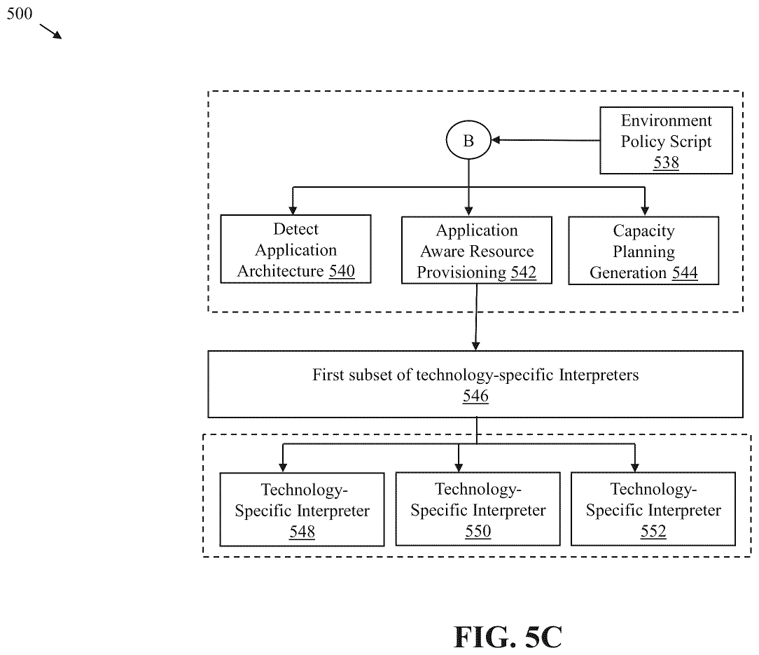

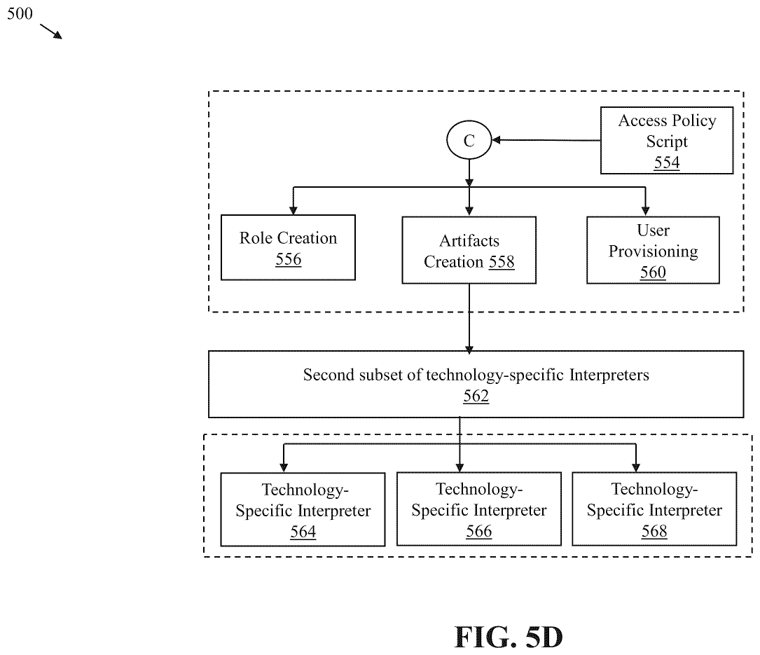

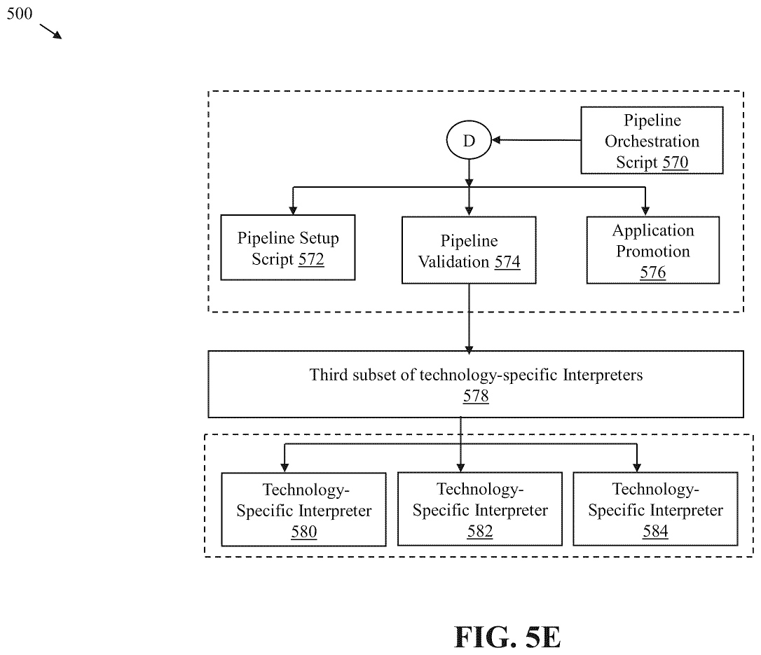

FIG. 3 is a block diagram that illustrates a detailed architecture 300 of the service application 112 of the system environment of FIG. 1, in accordance with another embodiment of the present disclosure. The architecture 300 is a modification (e.g., modified version) of the primary architecture 200 of the service application 112 that is shown in FIG. 2. The architecture 300 includes the user action designer 202, the user action catalog 203, the user action script compiler 204, the orchestrator 206, the plurality of gentech script generators 208, the plurality of technology-specific interpreters 210, the response converter 212, and the activity tracker 214. The architecture 300 has a description similar to the architecture 200. Additionally, the architecture 300 further includes a policy compiler 304 and a set of reverse interpreters 306 (hereinafter, the reverse interpreter 306). The orchestrator 206 is shown to include a policy design and orchestration engine 308, a policy regeneration and validation engine 310, and a deployment and enforcement engine 312. The policy compiler 304 may be configured to compile the policy template based on establishment of relevant links, connections, permissions, authentications, or the like required for enforcement of a policy template. The reverse interpreter 306 may be configured to communicate with a plurality of technologies and receive a set of feedback scripts based on an execution of SDLC stages, of a software product, based on the enforced policy template. The policy design and orchestration engine 308 may be configured to automate one or more operations associated with design and execution of the policy template. The policy regeneration and validation engine 310 may be configured to regenerate a compiled policy to meet an actual resource requirement of the software product. The policy regeneration and validation engine 310 may be further configured to validate whether the policy template is implementable/executable and whether it meets the actual resource requirements of the software product. The deployment and enforcement engine 312 may be configured to actually deploy the policy template by implementing various constraints within the architecture 200 that force the users to comply with the policy template. In some embodiments, the policy design and orchestration engine 308, the policy regeneration and validation engine 310, and the deployment and enforcement engine 312 constitute a policy enforcement engine (described in conjunction with FIGS. 5A-5E).

The user action designer 202 may render a UI (not shown) that enables the user (e.g., an administrator) to define policies for availability of microservices for the development of the software application during the define stage of the software development life cycle. In other words, the UI rendered by the user action designer 202 enables the user to select the plurality of microservices that are to be available for the development of the software application. Similarly, the user action designer 202 may be enabled to render an UI (not shown) that enables the user (e.g., an administrator) to create a new policy and edit the existing policies for availability of microservices during the development of the software application during the development stage of the software development life cycle. The selected plurality of microservices may include various technologies/microservices for developing various aspects (e.g., frontend, backend, database, or the like) of the software application. For the sake of brevity, the terms “technology stack” and “microservices” are used interchangeably throughout the disclosure. Examples of microservices for the development of the frontend may include AngularJS, React, Flutter, HTML, or the like. Examples of microservices for the development of the backend of the software application may include Java, Python, or the like. For the sake of brevity, it is assumed that only two microservices (e.g., the first and sixth microservices) are selected for the development of the software application. In other words, the plurality of microservices selected for the development of the software application may include only the first and sixth microservices. However, in an actual implementation, many other microservices or technologies may be selected for the various aspects (e.g., APIs, metadata management, or the like) of the development of the software application without deviating from the scope of the disclosure.

The primary architecture 200 further facilitates creation and enforcements of various policy templates that outline a set of resources required and a set of technologies used to provision those resources at each stage of the SDLC of a software product. Such a creation and enforcement of the policy templates are crucial for ensuring efficiency, consistency, and compliance across projects. These policy templates act as standardized guidelines that help developers and teams identify microservices, tools, infrastructure, and configurations necessary for various stages such as design, development, testing, deployment, and maintenance. By providing a clear framework, policy templates reduce ambiguity, streamline decision-making, and eliminate guesswork, thereby minimizing errors and inefficiencies. They also ensure alignment with organizational goals, regulatory requirements, and industry best practices, fostering a structured and predictable development process. Furthermore, by centralizing and documenting these details, policy templates improve collaboration among cross-functional teams and make it easier to adapt to changes in organizational policies or compliance standards, enhancing the agility and scalability of software development efforts.

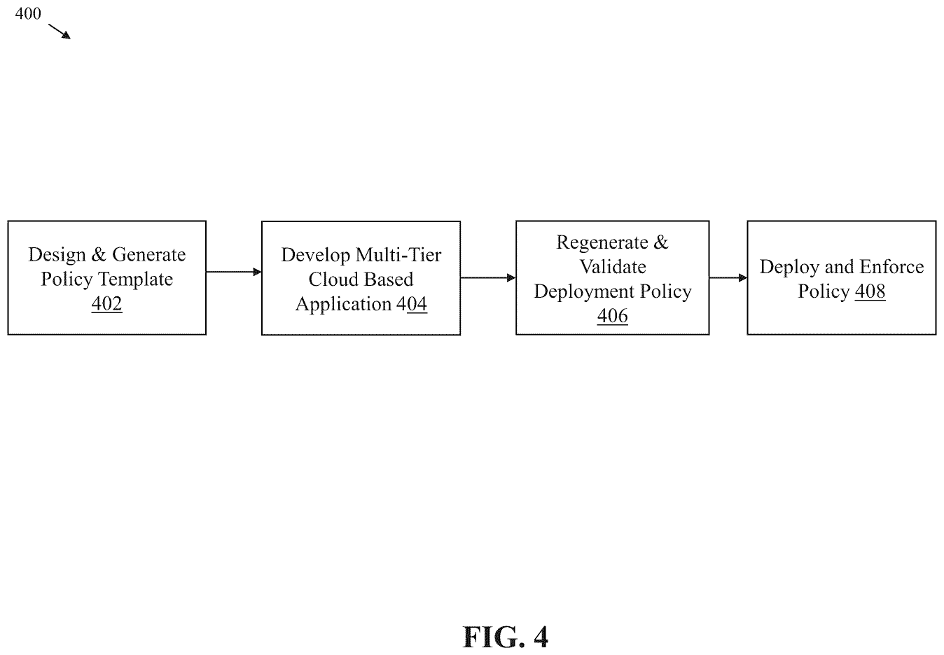

FIG. 4 is a block diagram 400 that illustrates different stages of creation and enforcement of a policy template for execution of a development stage and a deployment stage of a software product, in accordance with an embodiment of the present disclosure.

Generally, an SDLC of a software product includes a plurality of SDLC stages including the define stage, the design stage, the development stage, and the deployment stage. Development of the software product begins with define stage. The define stage may involve establishment of requirements, analysis of feasibility, solicitation of ideas from various stakeholders, creation of prototypes or proof-of-concept, estimation of costs, evaluation of risks, or the like. The define stage calls for the various stakeholders (e.g., developers, management, business partners, clients, or the like) to co-ideate and brainstorm to define technology and business requirements with respect to the software application. Creation of proofs-of-concept, evaluation of risks, estimation of costs, or the like often requires extensive collaboration between the various stakeholders.

The design stage of the software application includes designs or design mock-ups (e.g., user-experience design, user interface design, technical design, data organization design, or the like) for the software application may be prepared. Such designs may be prepared by various individuals or teams involved in the development of the software application. Therefore, synchronous progress in work, transparency, and collaboration among the individuals and/or teams is crucial in finalizing designs for the software application. However, in the organization such transparency and collaboration may not be always possible as different designs may be prepared using different tools or different design platforms.

The development stage of the software application may involve selection of a technology stack and writing code for developing the software application. Given today's competitive market, the organization may often need to adopt modern technologies (e.g., technologies for artificial intelligence, big data, data analytics, or DevOps) and modern practices (e.g., Agile) that enable the organization to optimize its operations and maintain an edge over competitors. To build or develop the software application (e.g., an e-commerce application, an e-learning application, or the like), the organization may need to select various point technologies (Hadoop, Apache Spark, or the like). The organization may be further required to build compatible point services on top of these point technologies. Business solutions (e.g., the software application) would need to be developed on top of the point services.

The deployment stage includes deployment or release of the software application in various deployment environments (e.g., a development environment, a quality analysis environment, a pre-production environment, a production environment, or the like). The deployment stage may include management of operations to deploy the software application. The deployment of the software application could be manual, scheduled, or automated. In one embodiment, the deployment stage may facilitate implementation of a continuous integration/continuous deployment (CI/CD) pipeline that enables automated deployment and/or delivery of the software application. The service application 112 allows for use of one or more CI/CD technologies or CI/CD automation tools (e.g., Jenkins, Circle CI, or the like) for implementation of the CI/CD pipelines. Various other tools, services, and/or technologies may be used for implementing various stages in the CI/CD pipeline, in conjunction with the one or more CI/CD automation tools.

Notably, a policy template may be created and enforced by the primary architecture 200 for each of the plurality of SDLC stages including the define stage, the design stage, the development stage, and the deployment stage.

For the sake of brevity, the ongoing description describes the creation and enforcement of the policy templates for the development stage and the deployment stage. It will be apparent to a person skilled in the art that policy templates for other SDLC stages may be created and implemented in a similar manner.

Referring to FIG. 4, shown are a plurality of stages based on which a policy template may be created and enforced. As shown, the plurality of stages includes a first stage ‘Design & Generate Policy Template’, a second stage ‘Develop Multi-Tier Cloud Based Application’, a third stage ‘Regenerate & Validate Deployment Policy’, and a fourth stage ‘Deploy and Enforce Policy’. Hereafter, the first stage ‘Design & Generate Policy Template’ is referred to as the first stage 402, the second stage ‘Develop Multi-Tier Cloud Based Application’ is referred to as the second stage 404, the third stage ‘Regenerate & Validate Deployment Policy’ is referred to as the third stage 406, and the fourth stage ‘Deploy and Enforce Policy’ is referred to as the fourth stage 408.

The first stage 402 of the creation and enforcement of the policy template involves identifying and collecting all necessary requirements, configurations, permissions, preferences, and constraints needed to define a comprehensive policy template. During this stage, stakeholders from various teams, such as development, operations, security, and compliance, collaborate to ensure all critical aspects of the policy are captured. One of the key activities in this stage is understanding resource requirements. This involves identifying the tools, technologies, infrastructure, and services needed at each stage of the software development lifecycle. By defining these resources in detail, the policy template can ensure efficient and accurate provisioning for different operations. Another important activity is specifying configurations, such as server environments, network settings, and integration parameters, which are essential for the proper utilization and compatibility of resources.

Additionally, the first stage 402 focuses on capturing permissions and access controls to ensure secure and compliant resource utilization. Determining user roles, permissions, and access levels helps enforce governance and protects sensitive systems and data. Similarly, organizational preferences, such as preferred tools, naming conventions, and workflow practices, are recorded to align the policy with internal standards and practices. Furthermore, compliance requirements, including regulatory, legal, and industry standards, are incorporated to ensure that the policy adheres to necessary guidelines and avoids potential risks.

Based on the capturing of the abovementioned information, the first stage 402 further involves creation of a policy template that meets each criterion indicated by the captured information. The policy template may include a first portion associated with the development stage of the software product and a second portion associated with the deployment of the software product. In the first portion, the policy template may include information associated with resources (for example, backend technology, frontend technology, data stores, processors, or the like) required for executing stage specific operations of the development stage. A stage specific operation of an SDLC stage may refer to an operation to be executed for completing the stage and transitioning to a subsequent stage. In the second portion, the policy template may include information associated with resources (for example, cloud environment configurations, cloud platform, CI/CD pipeline definitions, or the like) required for executing stage specific operations of the deployment stage.

An output of the first stage 402 is the policy template including the first portion indicative of a first subset of resources required for the development stage of the software product and a second subset of resources required for the deployment of the software product. Notably, the first subset of resources and the second subset of resources, collectively, constitute a set of resources required for development and deployment of the software product.

Based on completion of the first stage 402, the second stage 404 may be initiated. The stage 404 involves development of the software product based on the first portion of the policy template. The software product is assumed to have a multi-tiered architecture. Hence, the software product may be multi-faceted. For example, the software product may have a frontend, a backend, a datastore, a user interface, or the like. Notably, each facet may have to be developed and integrated with one or more other relevant facets of the software product.

The development of the software product guided by the policy template provides a structured and consistent framework that ensures alignment with organizational standards, preferences, and compliance requirements. The technologies specified in the policy template act as a foundation for implementing features, ensuring compatibility across the development environment while streamlining the selection process. By relying on predefined tools, developers can eliminate the guesswork associated with choosing the right technologies, reducing time and effort. Additionally, the configurations outlined in the policy template, such as server environments, network settings, and integration parameters, provide a standardized and optimized setup that minimizes errors and inefficiencies. This uniformity ensures a seamless development process, reduces onboarding time for new team members, and enables efficient collaboration across cross-functional teams.

The policy template also plays a crucial role in maintaining security and compliance throughout the execution of the development stage. Permissions and access controls specified within the policy template define user roles and responsibilities, ensuring that only authorized personnel have access to sensitive systems, tools, and resources. This not only enhances security but also helps enforce governance policies critical for meeting regulatory and compliance standards. Furthermore, by adhering to the organizational preferences and workflows documented in the policy template, the development process aligns with internal practices, fostering consistency across projects. Overall, the use of a policy template in the development phase eliminates ad-hoc decision-making, reduces the risk of errors, and accelerates project delivery, ensuring a robust and reliable software product that meets both technical and business objectives.

An output of the second stage 404 is the software product that is developed based on the policy template. This marks the completion of the second stage 404. Based on the completion of the second stage 404, the third stage 406 is initiated.

The third stage 406 involves determining one or more deviations between the set of resources to be provisioned based on the policy template and an actual set of resources required for the development and deployment of the software product. This ensures (i) alignment between the policy template and the software product and (ii) efficiency of the policy template. This third stage 406 involves a comparative analysis of the set of resources (for example, technologies, configurations, and permissions) outlined in the policy template against specific needs of the software product as identified during its development. Discrepancies may arise due to unique project requirements, evolving business needs, or unforeseen technical challenges that were not initially accounted for in the policy template. By identifying these differences, a set of modifications to be made to the policy template is determined by the primary architecture 200. The third stage 406 ensures that the set of resources being provisioned are both adequate and optimal for the software product's success while maintaining adherence to organizational standards and compliance guidelines. Additionally, resolving these discrepancies helps in refining the policy template for future use, improving its accuracy and adaptability over time.

Moreover, the third stage 406 further includes regeneration of the policy template based on the determined set of modifications. Specifically, the policy template may be modified to incorporate the set of modifications. The regenerated policy template may be in conformity with requirements and configurations of the software product and may meet the specific needs of the software product. Notably, the modification of the policy template may be optional and may be performed only when the set of resources associated with the policy template does not meet the requirements of the software product. Additionally, the third stage 406 includes validating the second portion of the policy template. The second portion of the policy template may be validated by deploying a demo software product prior to the deployment of the software product. The second portion of the policy template is considered to be validated based on a successful deployment of the demo software product based on the second portion of the policy template.

An output of the third stage 406 is the validated policy template and optionally, the modified policy template. This marks completion of the third stage 406. Based on the completion of the third stage 406, the fourth stage 408 is initiated.

The fourth stage 408 involves the deployment of the software product based on the policy template. The deployment of the software product based on the policy template involves utilizing the technologies, cloud environments, configurations, and other specifications outlined in the policy template to ensure a smooth and efficient process. The policy template acts as a blueprint, detailing the required infrastructure and provisioning mechanisms for deployment. For example, the policy template may specify cloud environments, such as AWS, Azure, or Google Cloud, along with the necessary configurations for setting up virtual machines, containers, storage, and networking. Additionally, the policy template may define tools and pipelines required for deployment automation, such as CI/CD platforms, scripting frameworks, and monitoring tools. By following the policy template, the deployment process becomes highly predictable and standardized, ensuring that the software product is deployed in an environment optimized for performance, scalability, and security.

Beneficially, the deployment of the software product based on the policy template provides a structured and standardized approach that ensures consistency and reliability throughout the deployment process. By leveraging the configurations, technologies, and permissions outlined in the policy template, deployment becomes a controlled and predictable activity. The infrastructure and tools provisioned according to the policy template are tailored to meet the organizational standards and project requirements, ensuring compatibility and optimal performance. Predefined configurations, such as server environments, network setups, and resource allocation, streamline the deployment process by reducing the need for manual interventions and minimizing errors. This ensures that the deployment environment is aligned with organizational standards, scalable, and capable of supporting the software product efficiently.

In addition to technical configurations, the policy template enforces critical security and compliance measures during deployment. Permissions and access controls defined in the template ensure that only authorized personnel can execute deployment tasks, mitigating the risk of unauthorized changes or security breaches. The use of the policy template also ensures adherence to compliance and regulatory requirements, which is particularly important in industries with strict governance standards. By following the structured guidelines of the policy template, developers/teams can proactively address compatibility issues, avoid deployment errors, and facilitate a smooth transition of the software product into production. This approach not only enhances the reliability of the deployment process but also ensures that the software product is ready for seamless use by end-users, aligning with both technical and business objectives.

To summarize, execution of the development stage and the deployment stage of the software product based on the policy template ensures a standardized, efficient, and secure process across the entire lifecycle. During development, the policy template provides predefined technologies, configurations, permissions, and compliance guidelines, enabling developers/teams to work in a consistent and structured manner. This reduces ambiguity, minimizes errors, and ensures alignment with organizational standards. Similarly, during deployment, the policy template serves as a blueprint, specifying the required cloud environments, infrastructure, tools, and security protocols, streamlining the transition of the software product into production. By enforcing access controls and adhering to compliance requirements, the template mitigates risks such as unauthorized changes and non-compliance. Overall, the use of a policy template fosters predictability, reduces inefficiencies, and ensures the delivery of a reliable, scalable, and secure software product.

FIGS. 5A-5E, collectively, represent a block diagram 500 that depicts a process workflow for creation and enforcement of a policy template using the primary architecture 300, in accordance with an embodiment of the present disclosure. The architecture 300 includes a policy template designer 502. Various operations associated with the policy template designer 502 are facilitated by the user action designer 202.

The policy template designer 502 is configured to present the plurality of SDLC stages via a user interface (UI) of a user device (for example, the user device 102a). Based on a selection of one or more SDLC stages (for example, the development stage, the deployment stage, or the like), the policy template designer may present a plurality of technologies available for execution of a set of stage specific operations associated with each of the one or more SDLC stages. Such selection may be performed via the UI of the user device. In addition, the selection may be performed for creation of a policy template for the selected one or more SDLC stages. For example, the policy template designer 502 may represent the define stage, the design stage, the development stage, and the deployment stage via the UI. Based on a selection of the define stage and the design stages, a plurality of technologies including GitHub, Jira, Confluence, AWS, Azure, Google Cloud Platform (GCP), or the like may be presented via the UI for execution of sets of stage specific operations associated with the development stage and the deployment (namely, deploy) stage.

Subsequently, the policy template designer 502 may be configured to record a first plurality of user actions for selecting a first set of technologies from the plurality of technologies for execution the one or more SDLC stages. In an example, the first set of technologies may include, but are not limited to, AWS, Azure for cloud-based deployment, Kubernetes cluster for container-based deployment, or any other technology/cloud based-platform for facilitating multi-cloud platform based deployment of the software product. The first plurality of user actions may be recorded based on generation and storage of metadata indicative of the selection of the first set of technologies. Specifically, the first set of technologies may be technologies selected for executing the set of stage specific operations of each of the one or more SDLC stages. The first plurality of user actions may be indicative of the policy template. That is to say that, the first plurality of user actions may be indicative of the set of stage specific operations of the one or more SDLC stages and one or more technologies for execution of the set of stage specific operations.

In some embodiments, the first plurality of user actions may be further indicative of a policy template including a first portion as a development policy 504 and a second portion as a deployment policy 506. The development policy 504 may include various tools, technologies, microservices, or the like selected for execution of the development stage of the software product. An enforcement of the development policy 504 may lead to the architecture 300 providing only the selected tools, technologies, microservices to be available for execution of the set of stage specific operations of the development stage.

In an instance, the development policy 504 may include source code management configuration 504a, development technologies 504b, and data technologies 504c available for execution of the set of stage specific operations associated with the development stage. For example, the development policy 504 of the policy template may be indicative of ‘React 2.0’ platform to be used for execution of the development stage of the software product. Therefore, the policy template may be enforced by presenting via the UI ‘React 2.0’ as only technology available for the execution of the development stage of the software product.

The deployment policy 506 may include an application topology 508, deployment standards 510, a CI/CD pipeline configuration 512, cloud environment 514, and access policy 516 that may be used for generation of a policy template script for enforcing the policy template. Hereinafter, the deployment policy 506 is referred to as the policy template.

The policy template designer 502 may be further configured to communicate the recorded first plurality of user actions or the metadata to a script generator 518. The script generator 518 may receive the first plurality of user actions or metadata from the policy template designer 502. Based on the first plurality of user actions or the metadata, the script generator 518 may be configured to generate a policy template script 520. The policy template script 520 may include an application topology subscript generated based on the application topology 508, a deployment standards subscript generated based on the deployment standards 510, a CI/CD pipeline configuration subscript generated based on the CI/CD pipeline configuration 512, a cloud environment subscript generated based on the cloud environment 514, and an access policy subscript generated based on the access policy 516.

The application topology subscript is indicative of a structural arrangement of components, services, and resources, along with their interactions and dependencies within a deployment environment of the software product. The application topology subscript provides a high-level blueprint of the software product's architecture, detailing elements such as front-end and back-end services, databases, APIs, middleware, and infrastructure components like servers, cloud platforms, containers, and storage systems. The application topology subscript also highlights communication pathways, data flows, network configurations, and security measures such as access controls and firewalls. Additionally, the application topology subscript encompasses provisions for scalability, redundancy, and fault tolerance to ensure high availability and reliability. By visualizing how the software product is distributed and interconnected, the application topology subscript enables teams to effectively plan, deploy, and maintain the software product while optimizing performance and managing changes.

The deployment standards subscript for the software product refers to a set of predefined guidelines and best practices that ensure the deployment process is consistent, reliable, secure, and efficient. The deployment standards subscript typically includes detailed configurations for infrastructure setup, such as server environments, containerization, and cloud provisioning, as well as requirements for continuous integration and continuous deployment (CI/CD) pipelines. The deployment standards subscript outlines security protocols, such as access controls, encryption, and compliance with industry regulations, to safeguard the deployment process. Additionally, the deployment standards subscript specify rollback strategies, monitoring and logging mechanisms, and scalability provisions to ensure smooth deployment and high availability of the product. By adhering to these standards, organizations can minimize errors, reduce downtime, and achieve a predictable and efficient deployment process across diverse environments.

The CI/CD pipeline (Continuous Integration/Continuous Deployment pipeline) configuration subscript is indicative of an automated workflow that streamlines the process of building, testing, and deploying code changes to ensure rapid and reliable delivery of updates. The CI/CD pipeline configuration subscript is designed to provide guidelines for creation of a CI/CD pipeline for the software product that automates tasks such as integrating code from multiple developers, running automated tests, and deploying the software product to production or staging environments. The CI/CD pipeline configuration subscript includes guidelines for creating one or more stages of the CI/CD pipeline. The one or more stages may include source code management, automated builds, testing, and deployment. For example, the CI/CD pipeline configuration subscript may be indicative of creation of a CI/CD pipeline to be implemented with GitHub Actions for version control and automated workflows, Jenkins for build automation, Selenium for automated testing, and AWS CodePipeline or Azure DevOps for deployment to cloud environments. In this setup, a developer pushing changes to a GitHub repository triggers the pipeline, which builds the code, runs tests, and deploys the updated application to an AWS EC2 instance or Azure App Service. This approach for creating the CI/CD pipeline ensures faster delivery cycles, reduces manual effort, and improves product quality by catching errors early in the process.

The cloud environment subscript is indicative of a virtualized infrastructure hosted on cloud platforms that provides the necessary resources and services to deploy, run, and manage the software product. The cloud environment subscript is further indicative of compute power (such as virtual machines or containers), storage, networking, and other infrastructure elements provisioned and managed through cloud service providers like Amazon Web Services (AWS), Microsoft Azure, GCP, or IBM Cloud. The cloud environment subscript enables flexibility, scalability, and reliability by allowing organizations to dynamically allocate resources based on demand and reduce dependency on physical hardware. The cloud environment subscript can be configured as public clouds (shared infrastructure), private clouds (dedicated infrastructure), or hybrid clouds (a mix of both). For instance, deploying a software product in a cloud environment might involve hosting the software product on AWS Elastic Beanstalk, using AWS S3 for storage, and leveraging AWS RDS for database services, while enabling auto-scaling and load balancing to ensure performance under varying workloads. Implementing the cloud environment subscript by enforcing the policy template simplifies the deployment process by offering pre-configured resources, automation capabilities, and integrated tools for monitoring, security, and compliance.

The access policy subscript is indicative of the rules and permissions that govern who can access the software product's resources, what actions they can perform, and under what conditions. The access policy subscript ensures secure and controlled access to the software product, its underlying infrastructure, and associated data, thereby protecting the software product's resources from unauthorized access and potential breaches. The access policy subscript typically specifies roles (e.g., admin, developer, end-user), permissions (e.g., read, write, execute), and access conditions (e.g., IP restrictions, multi-factor authentication). In a cloud environment, the access policy subscript is often enforced using Identity and Access Management (IAM) tools provided by a cloud provider of the cloud environment. For example, in AWS, the access policy subscript may define that developers have permission to update application code on AWS Code Commit, while only administrators can manage deployment pipelines in AWS Code Pipeline or access sensitive data in AWS RDS. Such policies also include compliance with organizational standards, least privilege principles, and audit logging to monitor access patterns and ensure security and governance. The policy template when enforced, implements a well-defined access policy, that safeguards the software product and its cloud resources while maintaining operational efficiency.

The script generator 518 may be further configured to incorporate an application driven policy 522 to the policy template script 520. The application driven policy 522 may be determined based on application tech and topology 524. The application tech and topology 524 may include information about specific requirements and characteristics of the software product. The application driven policy 522 determined based on the application tech and topology 524 may include specific requirements, characteristics, purpose (Proof of Concept or production-scale application), performance requirements, security considerations, compliance requirements, scalability needs, and any other relevant factors. The Proof of Concept (PoC) may focus on flexibility and agility, allowing for rapid experimentation and testing. Further, the PoC may have fewer constraints on resources and emphasize ease of deployment and modification. Further, the script generator 518 incorporates the unique characteristics of the software product, including its technology stack, network topology, and adherence to best practices to the policy template. In other words, the script generator 518 may incorporate the application driven policy 522, which is influenced by the specific requirements and characteristics of the software product, in the policy template. Different software products may have different resource needs, security considerations, and other factors that impact their deployment.

The script generator 518 may be further configured to incorporate optimal policy practices 526 in the policy template script 520. The optimal policy practices 526 may be guidelines and principles that organizations should follow when defining and implementing policies to ensure effective governance, compliance, and operational excellence. For example, if an application relies on a specific database or communication protocol, the optimal policy practices 526 would reflect those requirements. The script generator 518 incorporates the optimal policy practices 526 to the policy template script 520 for deploying applications based on practices and policies that are known to be suitable for software products with software configurations that may be similar to a software configuration of the software product for which the policy template is being created. Software configuration of a software product refers to a systematic arrangement and customization of its components, settings, and parameters to meet specific functional and performance requirements. The software configuration further includes definitions and management of the software's hardware dependencies, operating system compatibility, user interface preferences, application features, and integration with other systems or services. The software configuration also includes version control, ensuring that the right versions of software components are used together, and environmental settings, such as database connections, API endpoints, and security protocols. The software configuration ensures that the software product operates as intended, aligns with user needs, and supports scalability, maintainability, and reliability in diverse deployment scenarios.

To summarize, the script generator 518 may be configured to generate the policy template script 520 based on the first plurality of user actions, the application driven policy 522, and the optimal policy practices 526. The policy template script 520 may be in a format that is similar to user action script created by the user action designer 202. The policy template script 520 may be understandable to the architecture 300.

In some embodiments, the script generator 518 may be supported by the user action script compiler 204 and may leverage features of the user action script compiler 204 to generate the policy template script 520. The script generator 518 may communicate the policy template script 520 to a policy enforcement engine 528.

Referring now to FIG. 5B, the policy enforcement engine 528 may be configured to receive the policy template script 520. The policy enforcement engine 528 may be further configured to generate a set of provisioning scripts based on the policy template script 520. The set of provisioning scripts may be indicative of a set of resources that is to be provisioned for enforcing the policy template. The set of provisioning scripts may be further indicative of, for each resource of the set of resources, one or more technologies of the first set of technologies that is selected for provisioning the resource.

In some embodiments, the policy enforcement engine 528 may be supported by the plurality of gentech script generators 208. In such an embodiment, the policy enforcement engine 528, using a set of gentech script generators, may be configured to generate, based on the policy template script 520, the set of provisioning scripts in form of a set of gentech scripts. The set of gentech script generators may be compatible with the first set of technologies. That is to say that, the set of gentech script generators may support an underlying technology (for example, Python, Java, or the like) associated with the first set of technologies. Hence, the set of gentech script generators may generate, based on the policy template script 520, the set of provisioning scripts in form of the set of gentech scripts. The set of gentech scripts may be created for each of the first set of technologies and may be in a format that is understandable to the first set of technologies. The set of gentech scripts may include instructions for each of the first set of technologies which when executed facilitate provisioning of the set of resources.

A validation engine 530 of the policy enforcement engine 528 may be configured to validate, using the set of provisioning scripts or the set of gentech scripts, whether the set of resources to be provisioned using the set of provisioning scripts or the set of gentech scripts meets resource requirements of the software product. In an instance, the set of resources does not meet the resource requirements of the software product. In such an instance, the validation engine 530 may generate a set of updates to be incorporated in the policy template script 520 so that the set of resources provisioned based on the policy template meets the resource requirements of the software product.

The policy enforcement engine 528 may further include a cloud environment provisioning engine 532, a user access provisioning engine 534, and a pipeline setup engine 536. The cloud environment provisioning engine 532 may be configured to generate, based on a first section of the policy template script 520, an environment policy script 538.

Referring now to FIGS. 5B and 5C, the first section of the policy template script 520 may include information associated with a cloud environment and its configurations using which the software product is to be deployed. The first section of the policy template script 520 may further include one or more technologies of the first set of technologies using which one or more resources associated with the cloud environment are to be provisioned. The cloud environment provisioning engine 532 is configured to (i) detect application architecture 540, (ii) perform application resource aware provisioning 542, and (iii) perform capacity planning generation 544, to generate the environment policy script 538.

The cloud environment provisioning engine 532 is configured to automatically determine the multi-tiered architecture of the software product and generate resource, network, and security requirements for the software product based on its underlying technology architecture and the technologies to be used in each tier. By analyzing the multi-tiered architecture and technologies such as Java, React, or Python, the cloud environment provisioning engine 532 calculates resource demand for each tier, including compute power, memory, storage, and other infrastructure needs. The cloud environment provisioning engine 532 may determine appropriate network configurations required to support the multi-tiered architecture, such as subnets, load balancers, and routing rules, ensuring seamless communication between tiers. Additionally, the cloud environment provisioning engine 532 identifies and configures security groups, firewall rules, and access controls tailored to the specific requirements of each technology and tier, ensuring robust protection against unauthorized access. This automated approach ensures that all infrastructure, network, and security configurations are optimized for the application's architecture, reducing manual effort, eliminating errors, and ensuring alignment with organizational and compliance standards.

The cloud environment provisioning engine 532 is further configured to automate the process of determining and provisioning infrastructure resources for the software product based on its requirements, architecture, and organizational constraints. It begins by evaluating the resource requirements, including its purpose (whether Proof of Concept or production-scale deployment) and user demand, to determine the capacity needs. Using this capacity analysis, and factoring in the software product's architecture and tiered structure, the cloud environment provisioning engine 532 generates resource requirements for each tier, such as compute power, storage, and memory. It further considers the maximum capacity the organization can afford to ensure cost-effective provisioning, generating tailored resource creation scripts based on these constraints. Finally, the cloud environment provisioning engine 532 accounts for any user-defined capacity requirements to produce and provide resource creation scripts to subsequent deployment or configuration steps. This end-to-end automation ensures that resources are optimally provisioned, aligned with both technical and business constraints, and ready for seamless deployment.

The cloud environment provisioning engine 532 is further configured to automate the creation and configuration of a private cloud environment and associated cloud resources necessary for deploying the software product. The cloud environment provisioning engine 532 begins by setting up the private cloud infrastructure and generating configurations for both public and private subnets, strategically placing application tiers within the appropriate subnet based on security and performance requirements. The cloud environment provisioning engine 532 further automates the generation of load balancer configurations tailored to the software product's architecture, ensuring optimal traffic distribution and high availability. Additionally, the cloud environment provisioning engine 532 defines and generates security rules to manage both external communication and inter-subnet communication, safeguarding the environment while maintaining seamless connectivity between application tiers. Based on the architecture, the cloud environment provisioning engine 532 determines the required compute resources and generates scripts to create virtual machines that align with the specified configurations. This comprehensive approach streamlines the provisioning process, ensuring a secure, scalable, and efficient private cloud setup tailored to the software product's needs.

Referring to FIG. 5C, the cloud environment provisioning engine 532 may generate the environment policy script 538. The environment policy script 538 serves as a comprehensive blueprint detailing the application architecture, application aware resource provisioning, and capacity planning for the deployment of the software product. The environment policy script 538 includes a first set of instructions that when executed meets the capacity requirements of the software product based on its purpose, user demand, and architecture, along with resource specifications for each tier, such as compute, storage, and memory. The environment policy script 538 outlines the configured public and private subnets, load balancer setups for traffic optimization, and security rules for external and inter-subnet communication. Additionally, the environment policy script 538 contains network configurations, including subnets, routing, and firewall rules, and scripts for provisioning virtual machines and other cloud resources. The environment policy script 538 provides scalability provisions, compliance with organizational policies, and cost-efficient strategies. The environment policy script 538 is a set of instructions that when executed implements the infrastructure and ensures alignment with performance, security, and operational requirements for creation of cloud environment for the deployment of the software product.

The cloud environment provisioning engine 532 is further configured to communicate the environment policy script 538 to a first subset of technology-specific interpreters 546 of the first set of technology-specific interpreters. The environment policy script 538 may be indicative of a first subset of technologies of the first set of technologies that are selected for provisioning the first subset of resources of the set of resources. The first subset of technology-specific interpreters 546 may be communicatively associated with the first subset of technologies. Each of the first subset of technology-specific interpreters 546 may communicate with a corresponding technology based on the environment policy script 538. In some instances, the first subset of technology-specific interpreters 546 may generate a first subset of technology-specific scripts based on the environment policy script 538 and communicate the first set of technology-specific scripts to the first subset of technologies. Based on the communication the first subset of technologies may provision the first subset of resources as indicated by the first subset of technology-specific scripts that is generated based on the environment policy script 538. Alternatively, the first subset of technology-specific interpreters 546 may communicate the environment policy script 538 to the first subset of technologies. The first subset of resources may be provisioned based on the environment policy script 538.

In some embodiments, the environment policy script 538 may be transformed into a set of gentech scripts by one or more of the plurality of gentech script generators 208 that may be understandable to the first subset of technologies. Hence, the environment policy script 538 may be understandable to the first subset of technologies. Based on the environment policy script 538, the technologies may provision the one or more resources.

In an embodiment, the first subset of technology-specific interpreters 546 may include technology-specific interpreters 548-552. In other embodiments, the first subset of technology-specific interpreters 546 may include additional or different technology-specific interpreters. In an example, the first subset of technology-specific interpreters 546 may include AWS interpreter, Azure interpreter, and GCP interpreter configured to communicate with the AWS, Azure, and GCP platforms for provisioning of the first subset resources of the set of resources for deployment of cloud environment and related configurations for the software product.

Referring now to FIGS. 5B and 5D, the user access provisioning engine 534 may be configured to generate, based on a second section of the policy template script 520, an access policy script 554. The second section of the policy template script 520 may include information associated with one or more users, roles, and permissions associated with access to the software product and its resources. The second section of the policy template script 520 may further include a second subset of technologies of the first set of technologies using which a second subset of resources, of the set of resources, associated with access control, users, roles, and permissions is to be performed. The user access provisioning engine 534 is configured to perform (i) role creation 556, (ii) artifact creation 558, and (iii) user provisioning 560, to create the access policy script 554.

The user access provisioning engine 534 is configured to automate the process of role creation and permission assignment across development and deployment tools and technologies used in the software product. It begins by analyzing the development and deployment tools and technologies utilized in the software product, such as version control systems, CI/CD pipelines, monitoring tools, and cloud platforms, to identify the specific roles that need to be created in each tool and technology. The user access provisioning engine 534 further evaluates the software product's requirements and user personas to determine the permissions that each role must have, ensuring alignment with organizational policies, security standards, and operational needs. By streamlining role and permission management, the user access provisioning engine 534 reduces manual effort, minimizes errors, and ensures secure and efficient access control across all development tools used in the application lifecycle. Once the roles and permissions are defined, the user access provisioning engine 534 generates the access policy script 554 required to create these roles or identities within the respective tools or technologies, automating the provisioning process. The access policy script 554 may include a second set of instructions that when executed implement roles, identities, or permissions within the respective tools or technologies.

The user access provisioning engine 534 is further configured to generate instructions in the access policy script 554 that when executed automate the creation of necessary artifacts in various tools or technologies based on the software product's architecture and deployment environment configuration. By analyzing the software product's structure and deployment needs, the user access provisioning engine 534 identifies the specific artifacts required in each tool or technology, such as projects or organizations in source control management (SCM) tools like GitHub or GitLab, repositories in artifact management tools like Nexus or JFrog Artifactory, and pipelines in CI/CD tools like Jenkins or Azure DevOps. Once the required artifacts are determined, the user access provisioning engine 534 generates the access policy script 554 having the instructions to create these artifacts within the respective tools or technologies, ensuring proper alignment with the software product's architecture and deployment environment. This automation not only streamlines the artifact creation process but also ensures consistency, reduces manual errors, and accelerates the setup of a well-organized development and deployment environment.

The user access provisioning engine 534 is further configured to automate user and access management by dynamically provisioning access to application-specific artifacts based on the users' roles. When users are added to the software product, the user access provisioning engine 534 uses predefined role scripts to assign appropriate access permissions to the relevant artifacts, such as repositories, projects, or environments, ensuring that each user has the required access level to perform their responsibilities. Additionally, the user access provisioning engine 534 continuously monitors user changes, such as new users being added or existing users being removed or modified, and automatically updates access provisioning to reflect these changes in real-time. This eliminates the need for manual intervention, reduces errors, and ensures secure and efficient access control. By streamlining user and access management, the user access provisioning engine 534 enhances operational efficiency while maintaining alignment with organizational policies and compliance requirements. The abovementioned operations are performed by the user access provisioning engine 534 by generating or modifying the access policy script 554.

The user access provisioning engine 534 is further configured to communicate the access policy script 554 to a second subset of technology-specific interpreters 562 of the first set of technology-specific interpreters. The access policy script 554 may be indicative of a second subset of technologies of the first set of technologies that are selected for provisioning a second subset of resources of the set of resources. The second subset of technology-specific interpreters 562 may be communicatively associated with the second subset of technologies. The second subset of technology-specific interpreters 562 may communicate with the second subset of technologies based on the access policy script 554. The second subset of technology-specific interpreters 562 may generate a second subset of technology-specific scripts based on the access policy script 554 and communicate the second subset of technology-specific scripts to the second subset of technologies. Based on the communication, the second subset of technologies may receive the second subset of technology-specific scripts and provision the second subset of resources as indicated by the second subset of technology-specific scripts that is generated based on the access policy script 554 for applying relevant access control policies. Alternatively, the second subset of technology-specific interpreters 562 may communicate the access policy script 554 to the second subset of technologies. The second subset of resources may be provisioned based on the access policy script 554.

In some embodiments, the access policy script 554 may be a set of gentech scripts understandable to the second subset of technologies. Hence, the access policy script 554 may be understandable to the second subset of technology-specific interpreters 562. Based on the access policy script 554, the second subset of technologies may provision the second subset of resources.

In an embodiment, the second subset of technology-specific interpreters 562 may include technology-specific interpreters 564-568. In other embodiments, the second subset of technology-specific interpreters 562 may include additional or different technology-specific interpreters. In an example, the second subset of technology-specific interpreters 562 may include GitHub interpreter, Jira interpreter, and Confluence interpreter configured to communicate with the GitHub, Jira, and Confluence platforms for provisioning of one or more resources of the set of resources for deployment of cloud environment and related configurations for the software product.

Referring now to FIGS. 5B and 5E, the pipeline setup engine 536 may be configured to generate, based on a third subset of the policy template script 520, a pipeline orchestration script 570. The third subset of the policy template script 520 may include information associated with various pipeline stages using which the software product is to be deployed. The third subset of the policy template script 520 may further include a third subset of technologies of the first set of technologies using which a third subset of resources of the set of resources associated with the CI/CD pipeline creation, stages, automation, or the like is to be performed. The pipeline setup engine 536 is configured to perform (i) creation of a pipeline orchestration script 570, (ii) pipeline validation 574, and (iii) application promotion 576, to create the pipeline orchestration policy 570.

The pipeline setup engine 536 generates the pipeline setup script 572 for automating the creation and configuration of integration and deployment pipelines for the software product by dynamically defining the pipeline stages required based on the software product's requirements, purpose (e.g., Proof of Concept or production-scale), and architecture. The pipeline setup engine 536 analyzes the third subset of the policy template script 520 to determine the number and type of stages needed in the pipeline, such as build, test, deploy, and monitoring stages. The pipeline setup engine 536 then generates the pipeline setup script 572 to manage the prerequisites for pipeline execution, ensuring a seamless setup. For each stage, the pipeline setup engine 536 creates a detailed definition and configures application-specific parameters, such as resource allocation, environment variables, and execution triggers. Additionally, the pipeline setup engine 536 defines and configures security stages, integrating checks and compliance measures tailored to the application's requirements, purpose, and architecture. The pipeline setup script 572 includes instructions that when executed by a third subset of technologies of the first set of technologies may provision creation and automation of the pipeline for integration and deployment of the software product.

The pipeline setup engine 536 is further configured to automate the verification and validation of pipeline stages to ensure they meet application requirements and execute seamlessly. The pipeline setup engine 536 uses technology-specific interpreters to verify and validate the pipeline stages of the pipeline generated for the integration and deployment of the software product. Such validation and verification may be performed to identify any inconsistencies, errors, or misconfigurations. The pipeline setup engine 536 further analyzes the validation findings and determines the changes required to address these issues, such as correcting syntax, updating parameters, or modifying configurations. These findings and required updates are reflected in the pipeline setup script 572, enabling the regeneration of an updated and accurate pipeline setup script 572. This iterative process ensures that the pipeline script is thoroughly validated, optimized, and ready for execution, enhancing the reliability and efficiency of the pipeline setup and reducing the risk of deployment errors.

The pipeline setup engine 536 automates the process of defining and implementing a promotion strategy based on the software product's requirements and architecture. The pipeline setup engine 536 analyzes the software product's characteristics and identifies a suitable promotion strategy, such as progressive rollout, blue-green deployment, or canary release. The pipeline setup engine 536 evaluates the defined deployment environments, such as staging, testing, and production, to identify environment-specific changes required in the promotion scripts. Once these changes are determined, the pipeline setup engine 536 generates a promotion pipeline script, incorporating the appropriate configurations and parameters for each environment. By streamlining the creation of promotion strategies and scripts, the pipeline setup engine 536 ensures a seamless, secure, and efficient application promotion process, reducing errors and enabling smooth transitions between deployment stages.

The pipeline setup engine 536 is further configured to communicate the pipeline orchestration script 570 including the promotion pipeline scripts to a third subset of technology-specific interpreters 578 of the first set of technology-specific interpreters. In other words, the pipeline setup engine 536 may communicate the pipeline orchestration script 570 to the third subset of technology-specific interpreters 578. The pipeline orchestration script 570 may be indicative of a third subset of technologies of the first set of technologies that are selected for provisioning the third subset of resources of the set of resources. The third subset of technology-specific interpreters 578 may be communicatively associated with the third subset of technologies. The third subset of technology-specific interpreters 578 may communicate with the third subset of technologies based on the pipeline orchestration script 570. The third subset of technology-specific interpreters 578 may generate a third subset of technology-specific scripts and communicate the third subset of technology-specific scripts to the third subset of technologies. Based on the communication, the third subset of technologies may provision the third subset of resources as indicated by the third subset of technology-specific scripts that is generated based on the pipeline orchestration script 570. Alternatively, the third subset of technology-specific interpreters 578 may communicate the pipeline orchestration script 570 to the third subset of technologies. The third subset of resources may be provisioned based on the pipeline orchestration script 570. The third subset of resources may be provisioned for creating and automating the deployment pipeline and promotion pipeline indicated by the pipeline orchestration script 570 including the pipeline setup script 572 and the promotion pipeline scripts, respectively.

In some embodiments, the pipeline orchestration script 570 may be a set of gentech scripts understandable to the third subset of technologies of the first set of technologies. Hence, the pipeline orchestration script 570 may be understandable to the third subset of technology-specific interpreters 578. The pipeline orchestration script 570 may include a third set of instructions that when executed may provision the third subset of resources using the third subset of technologies. Based on the pipeline orchestration script 570, the third subset of technologies may provision the third subset of resources for creating and automating the deployment pipeline and the promotion pipeline for the deployment of the software product.

In an embodiment, the third subset of technology-specific interpreters 578 may include technology-specific interpreters 580-584. In other embodiments, the third subset of technology-specific interpreters 578 may include additional or different technology-specific interpreters. In an example, the third subset of technology-specific interpreters 578 may include Jenkins interpreter, Bamboo interpreter, and GitHub Action interpreter configured to communicate with the Jenkins, Bamboo, and GitHub platforms for provisioning of one or more resources of the set of resources for deployment of cloud environment and related configurations for the software product.

Notably, the environment policy script 538, the access policy script 554, and the pipeline orchestration script, collectively, constitute the set of provisioning scripts. Further, the first subset of technology-specific interpreters 546, the second subset of technology-specific interpreters 562, and the third subset of technology-specific interpreters 578, collectively, constitute the first set of technology-specific interpreters. Notably, the first, second, and third subset of technology-specific scripts, collectively, constitute a set of technology-specific scripts generated by the set of technology-specific interpreters based on which the set of resources may be provisioned by the set of technologies. Similarly, the first subset of technologies, the second subset of technologies, and the third subset of technologies, collectively, constitute the first set of technologies. Additionally, the first subset of resources, the second subset of resources, and the third subset of resources, collectively, form the set of resources. In other words, the first subset of resources, the second subset of resources, and the third subset of resources provisioned based on communication of each technology-specific interpreter of the first subset of technology-specific interpreters 546, the second subset of technology-specific interpreters 562, and the third subset of technology-specific interpreters 578, collectively, constitute the set of resources to be provisioned for the deployment of the software product. The provisioning of the set of resources by the first set of technologies enforces the policy template for the deployment of the software product.

In some embodiments, the first set of technology-specific interpreters may be configured to convert the received set of provisioning scripts (i.e., the environment policy script 538, the access policy script 554, or the pipeline orchestration script 570) into the set of technology-specific scripts that is in a format that is compatible with the first set of technologies as described in conjunction with FIG. 2. The first set of technology-specific interpreters may be further configured to communicate the set of technology-specific scripts to the first set of technologies. The first set of technologies may receive the set of technology-specific scripts and may provision the set of resources for the software product, based on the received set of technology-specific scripts.

In some embodiments, the reverse interpreter 306 (shown in FIG. 3) may receive, based on execution of the set of stage specific operations of the deployment stage, a set of feedback scripts from the first set of technologies. The script generator 518 may be further configured to generate an updated policy template script based on the set of feedback scripts. Subsequently, the policy enforcement engine 528 may update the set of provisioning scripts to reflect the updated policy template script. The first set of technology-specific interpreters is further configured to communicate with the first set of technologies further based on the updated provisioning script. The provisioned set of resources may be modified/updated based on such communication.

In an example, the set of feedback scripts may be indicative of a sufficient provisioning of data storage. Therefore, the policy template script may be updated to indicate an increase in the provisioned data storage. Hence, the set of provisioning scripts may be updated to reflect the updates/changes in the policy template script. Consequently, the first set of technology-specific interpreters may communicate with at least one of the first set of technologies based on the updated set of provisioning scripts such that at least one of the first set of technologies implements the increase in the provisioned data storage.

In some embodiments, the validation engine 530 may be configured to use the policy template to execute one or more SDLC stages (for example, the development stage, the deployment stage, or the like) associated with a demo software product. Such execution of the one or more SDLC stages of the demo software product may be performed prior to the enforcement of the policy template for the software product. The demo software product may have an architecture, configuration, permissions, or the like same as the software product. Based on the execution, the validation engine 530 may be configured to generate a set of updates for the policy template script 520. The set of updates may be generated based on one or more issues, anomalies, technical errors, discrepancies, or the like determined during the abovementioned execution. Based on the set of updates, the script generator 518 may modify the policy template script 520. The policy template may be enforced using the policy template script 520 as described above. The validation engine 530 may validate the policy template script 520 when the execution of the SDLC stages of the demo software product is completed successfully. The validation of the policy template script 520 may be indicative of a workability/usability thereof using the first set of technologies.

In some embodiments, the policy template designer 502 may be configured to record a second plurality of user actions for selecting a second set of technologies from the plurality of technologies. The second set of technologies may have zero or more technologies that are also included in the first set of technologies. The second set of technologies may be selected for modifying the policy template. That is to say that the second set of technologies may be selected for making a change in the first set of technologies being used for execution of one or more stage specific operations of the set of stage specific operations (for example, the define stage and the design stage). In other words, the second set of technologies of the plurality of technologies may be selected for execution of one or more stage specific operations of the set of stage specific operations of the one or more SDLC stages. In an example, the second set of technologies may include technologies used for the creation and the automation of the pipeline stages for integration and deployment of the software product. Based on the selection of the second set of technologies, the script generator 518 may update the policy template script 520 to reflect the changes in the first set of technologies selected for the execution of the one or more stage specific operations of the set of stage specific operations.

For example, the updated policy template script 520 may reflect the changes in the first set of technologies selected for the creation and the automation of the pipeline stages for integration and deployment of the software product. The policy enforcement engine 528 is further configured to generate, based on the updated policy template script 520, a set of revised provisioning scripts that reflects the change in the first set of technologies selected for the execution of the one or more stage specific operations of the set of stage specific operations. Subsequently, the policy enforcement engine 528 may communicate the set of revised provisioning scripts to one or more technology-specific interpreters of the plurality of technology-specific interpreters. The set of revised provisioning scripts may be indicative of a change in the set of resources and/or a change in the first set of technologies. The one or more technology-specific interpreters may communicate, based on the set of revised provisioning scripts, with the second set of technologies to update the set of resources provisioned for execution of the set of stage specific operations as described throughout the description.

The primary architecture 300 may further include a set of predefined policy templates. Each of the set of predefined policy template scripts may be indicative of a corresponding second set of technologies for execution of the set of stage specific operations of each of the one or more SDLC stages. A predefined policy template script may be selected based on a software configuration of a software product to be developed and deployed being similar to the policy template. For example, an online chatting application may be developed and deployed using a policy template for developing and deploying a web-based application. Based on the selection of the predefined policy template script, the enforcement of the predefined policy template script for developing and deploying the software product is performed by generating a predefined provisioning script by the policy enforcement engine 528 in a manner similar to the enforcement of the policy template script 520.

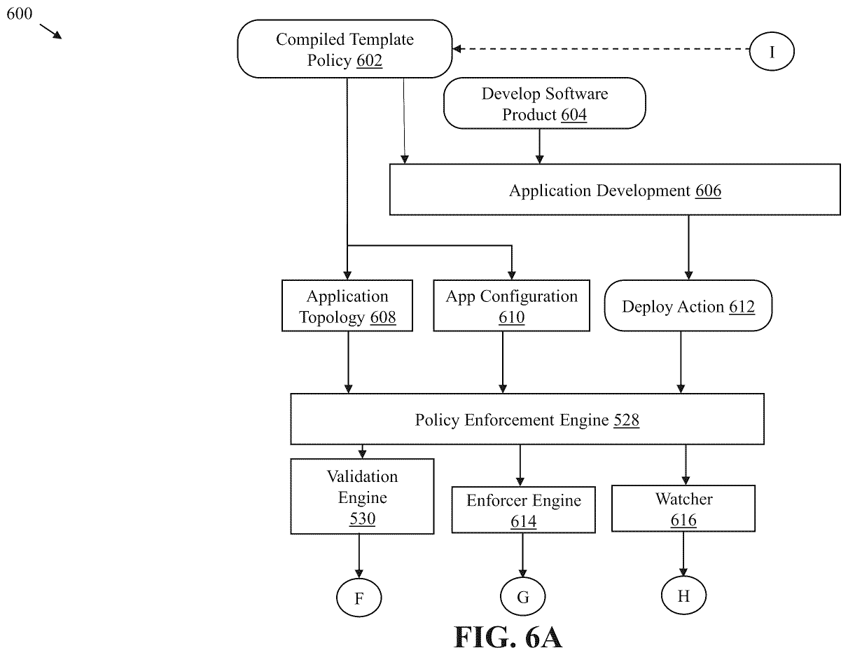

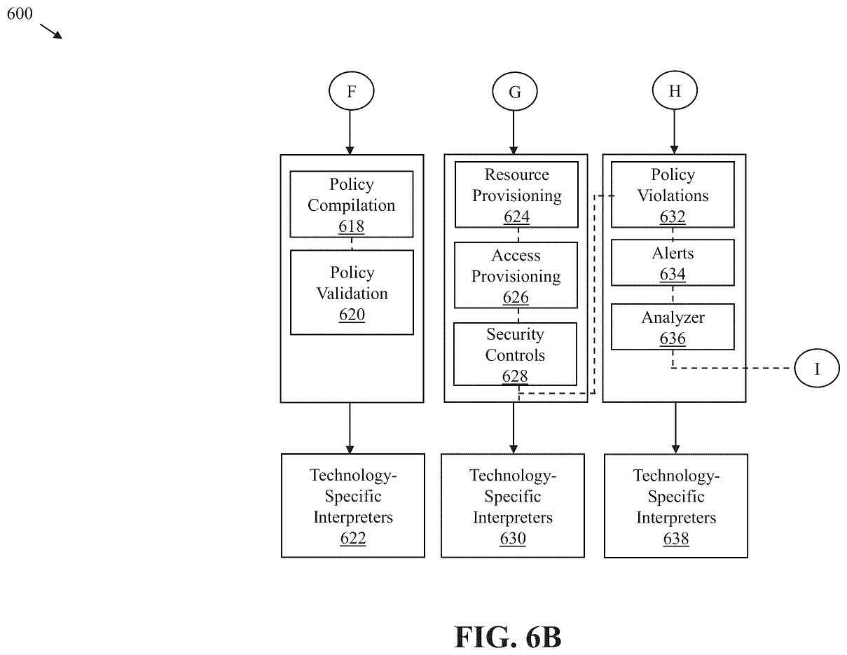

FIGS. 6A and 6B, collectively, illustrate a block diagram 600 for enforcing a policy template for a software product, in accordance with an embodiment of the present disclosure. Referring to FIG. 6A, a compiled policy template 602 refers to a policy template that has been created previously and complied as described previously based on operations of various modules shown and described with respect to FIGS. 5A-5E. At 604, the architecture 300 may receive an instruction to develop a software product 604. The software product 604 may be a software application (namely, an application). Based on the instruction, at 606 the software product may be developed in accordance with a development policy of the compiled policy template 602. The policy template designer 502 may use the compiled policy template 602 to determine an application topology 608 and an application configuration 610 associated with the policy template that is to be used for the development and deployment of the software product. Subsequently, the policy template designer 502 may perform a deploy action 612. The deploy action 612 may correspond to updating/customizing the compiled policy template 602 to meet specific requirements of the software product. As shown, the policy enforcement engine 528 includes the validation engine 530, an enforcer engine 614, and a watcher 616.

Referring now to FIG. 6B, the validation engine 530 may perform validation of the compiled policy template as described in conjunction with FIGS. 5A-5E. For example, the validation engine 530 may perform policy compilation 618 and policy validation 620. Subsequently, the compiled policy template 602 is enforced using relevant technology-specific interpreters 622.

The enforcer engine 614 may be configured to perform resource provisioning 624, access provisioning 626, and security controls 628 as described previously for the policy enforcement engine 528. The resource provisioning 624 involves the deployment of cloud resources in accordance with the application architecture or topology, considering factors such as a multi-tier setup which includes creating a Virtual Private Cloud (VPC) and defining subnets to establish a structured and scalable network environment. The allocation of resources is customized to meet the specific requirements and design of the application, ensuring optimal performance and resource utilization. The access provisioning 626 includes implementing policies to grant appropriate access levels for users across various tools integral to the application development and deployment which includes setting up access controls based on defined policies, ensuring that users have the necessary permissions to interact with tools like source code management (SCM) systems, artifacts management tools, and other components in the software development lifecycle. The security controls 628 form a crucial layer in the deployment process, encompassing the establishment of measures such as security groups, network access control rules, and application access rules. These controls are designed to safeguard the infrastructure and applications from unauthorized access, ensuring a secure cloud environment. Subsequently, the compiled policy template 602 is enforced using relevant technology-specific interpreters 630.

The watcher tool 616 (also, referred as a watcher) is a monitoring tool which monitors the deployed policies upon deployment of the software product. The watcher tool 616 monitors the creation and enforcement of the policy template. The watcher 616 analyses the enforced policy template based on the provisioned set of resources or an execution of the set of stage specific operations of the one or more SDLC stages. The watcher 616 is further configured to generate a set of recommendations associated with the enforced policy template. The set of recommendations is generated based on the set of provisioned resources being divergent from a set of required resources for execution of the set of stage specific operations of the one or more SDLC stages of a software product implemented by enforcing the policy template. The set of resources being divergent corresponds to the provisioned set of resources being not sufficient or suitable for the development or the deployment of the software product in accordance with the enforced policy template.

The watcher tool 616 may be further configured to identify policy violations 632 and generate alerts 634 to the policy enforcement engine 528 based on the identification of the policy violations 632. The watcher tool 616 may be further configured to analyze, using an analyzer 636, the policy violations and generate the set of feedbacks. The alerts 634 or the set of feedbacks may be used to update/modify the policy template scripts for continuous deployment. For example, a cloud-based e-commerce platform that utilizes the watcher tool 616 for monitoring its security policies. As the platform continuously deploys updates and new features, the watcher tool 616 actively monitors the deployed software application policies in real-time. In an instance, where a new deployment may introduce a security policy violation, the watcher tool 616 may identify the security policy violation and generate an alert (for example the alerts 634) to the policy enforcement engine 528. This enables the development team to address and rectify the violation by updating the policy template scripts. The watcher tool 616 plays a crucial role in maintaining a secure and compliant environment, ensuring that any policy deviations are promptly addressed during the continuous deployment process of the e-commerce platform. Subsequently, the compiled policy template 602 may be updated using the set of feedbacks is enforced using relevant technology-specific interpreters 638.

Having described the creation, compilation, and enforcement of the policy templates, the description now moves towards user interface (UI) that enables such creation, compilation, and enforcement of the policy templates.

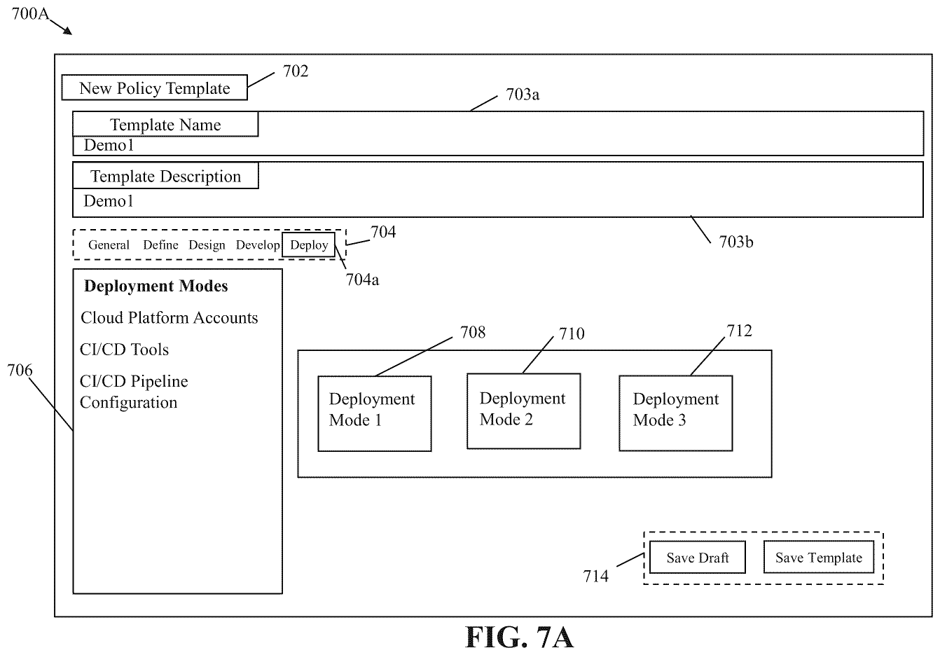

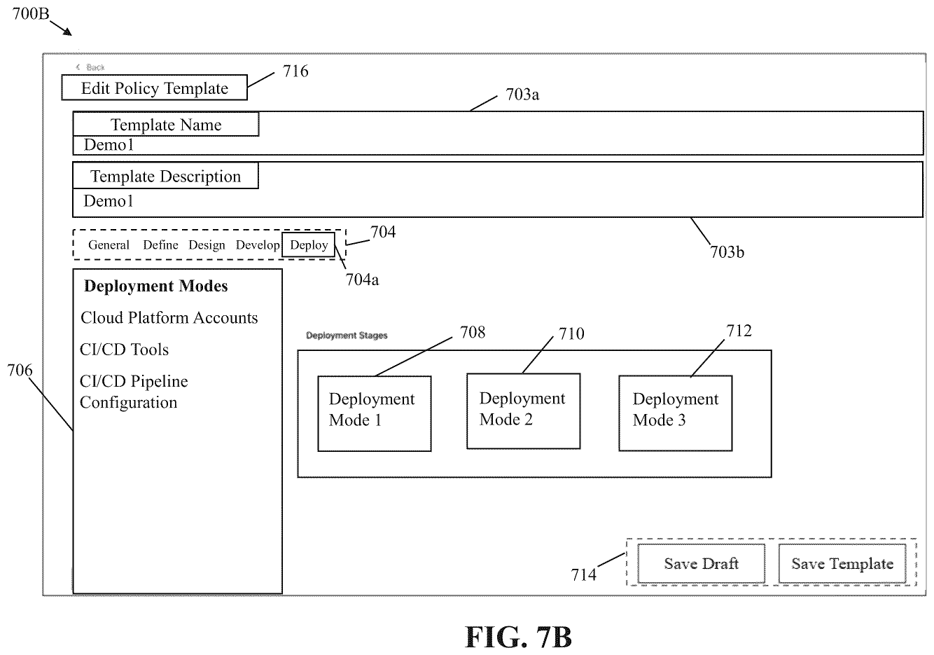

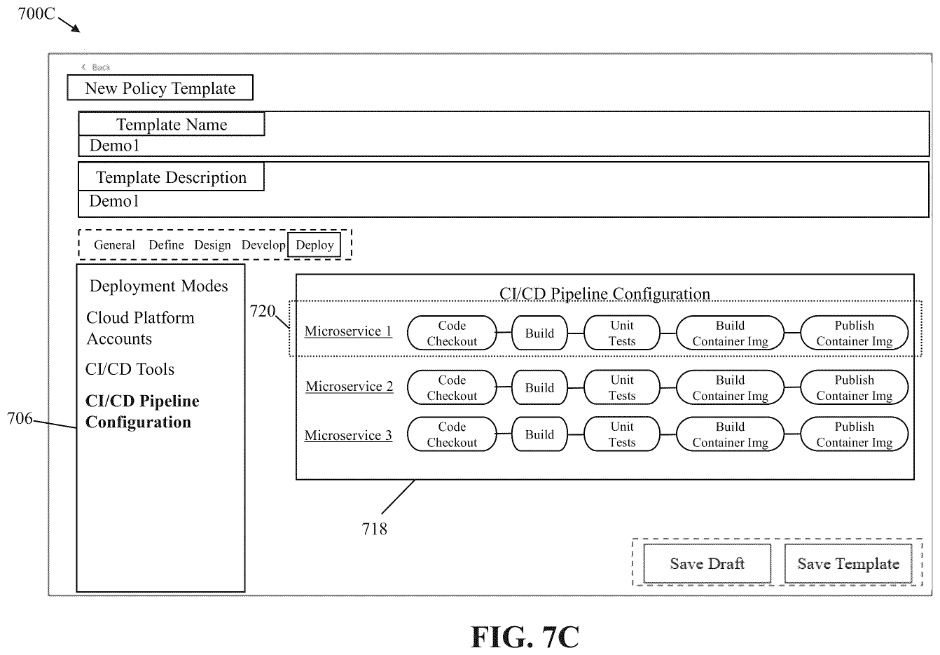

FIGS. 7A-7C, collectively, illustrate an exemplary user interface that enables creation, compilation, and enforcement of the policy templates, in accordance with an embodiment of the present disclosure. Referring to FIG. 7A, a UI screen 700A is presented. The UI screen 700A presents a plurality of user-selectable options that enable users to create policy templates associated with the deployment of the software product. The UI screen 700A presents a user selectable option 702 ‘New Policy Template’ that when selected enables a user to create a ‘New Policy Template’. The user selectable option 702 enables the user to provide various details associated with the new policy template. Various details associated with the new policy template may include a template name (shown within a box 703a) of the new policy template and a template description (shown within a box 703b) of the policy template. As shown within a dashed box 704, the policy template may be created for the plurality of SDLC stages ‘General, Define, Design, Develop, and Deploy’ of the software product. The general stage may correspond to policies that are to be applied globally at each SDLC stage of the software product.

For the sake of brevity, FIG. 7A depicts creation of a policy template for the deploy (namely, deployment) stage (shown within a box 704a). Based on the selection of the deploy stage, a plurality of facets of the deploy stage are presented within a box 706. The plurality of facets of the deploy stage may include for example, ‘Deployment Modes’, ‘Cloud Platform Accounts’, ‘CI/CD Tools’, ‘CI/CD Pipeline Configuration’. The UI screen 700A enables selection of one or more of the plurality of facets of the deploy stage. As shown, the selected facet may be ‘Deployment Modes’ shown in bold. Based on the selection of ‘Deployment Modes’, a plurality of technologies available for execution of the stage specific operations of the deploy stage may be presented via the UI screen 700A. As shown, the plurality of technologies may include ‘Deployment Mode 1’ (shown within a box 708), ‘Deployment Mode 2’ (shown within a box 710), and ‘Deployment Mode 3’ (shown within a box 712). One or more deployment modes may be selected as the first set of technologies from the plurality of technologies presented via the UI screen 700A. In an example, the plurality of technologies may include Kubernetes, Terraform, Red Hat, Docker, or the like.

Upon selection of the first set of technologies, the new policy template may be saved as a draft or as a template based on selection of user selectable options ‘Save Draft’ or ‘Save Template’, respectively, shown with a dashed box 714. Based on selection of the user selectable option ‘Save Template’, the policy template can be used for future applications of similar nature or operations. Based on selection of the user selectable option ‘Save Draft’, the policy template may be saved specifically for the software product being developed and/or deployed. Referring now to FIG. 7B, the policy template may be modified using one or more edit options (for example, edit policy template 716) available with the UI screen 700B of the architecture 300.

Referring now to FIG. 7C, based on a selection of the facet ‘CI/CD Pipeline Configuration’ shown in bold within the box 706, a UI screen 700C may be presented. As shown within a box 718, the UI screen 700C presents a plurality of user-selectable options that enable users to configure various pipeline stages associated with a plurality of tools, microservices, technologies or the like available for developing and deploying the software product.

As shown within a dotted box 720, pipeline stages for developing and deploying a software product developed using a ‘Microservice 1’ may include pipeline stages ‘Code Checkout’, ‘Build’, ‘Unit Tests’, ‘Build Container Image (Img)’, and ‘Publish Container Img’. The UI screen 700C may further present similar or different pipeline stages for other microservices for example ‘Microservice 2’ and ‘Microservice 3’. Examples of microservices may include, but are not limited to, React, Java, or the like. Notably, the UI screen 700C may be used to perform different operations (for example, define, design, modify, or the like) for creating pipeline stages to be used for deploying the software product using the policy template.

It will be apparent to a person skilled in the art that the architecture 300 shown herein may similarly implement various user interface screens that enable selection and input of data and/or choices for creation and enforcement of the policy template.

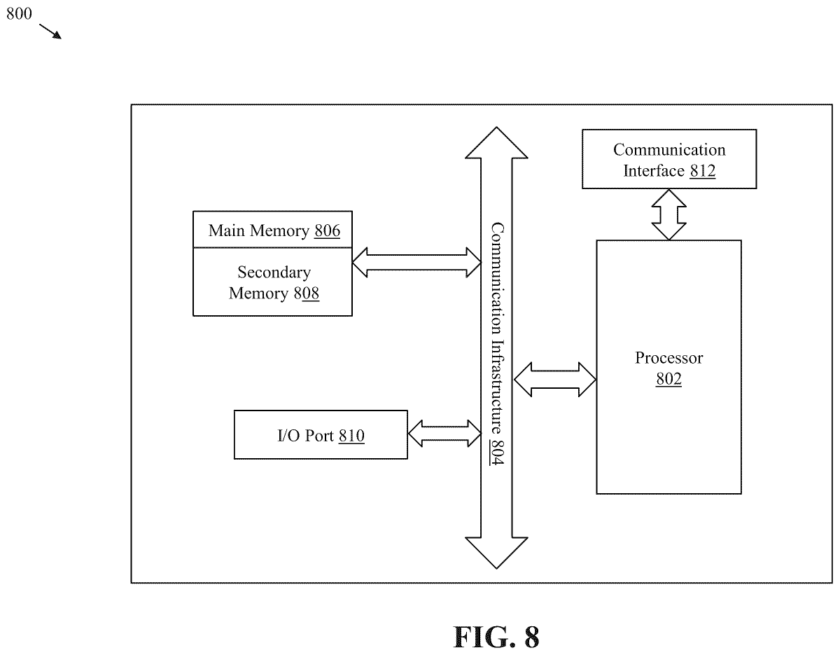

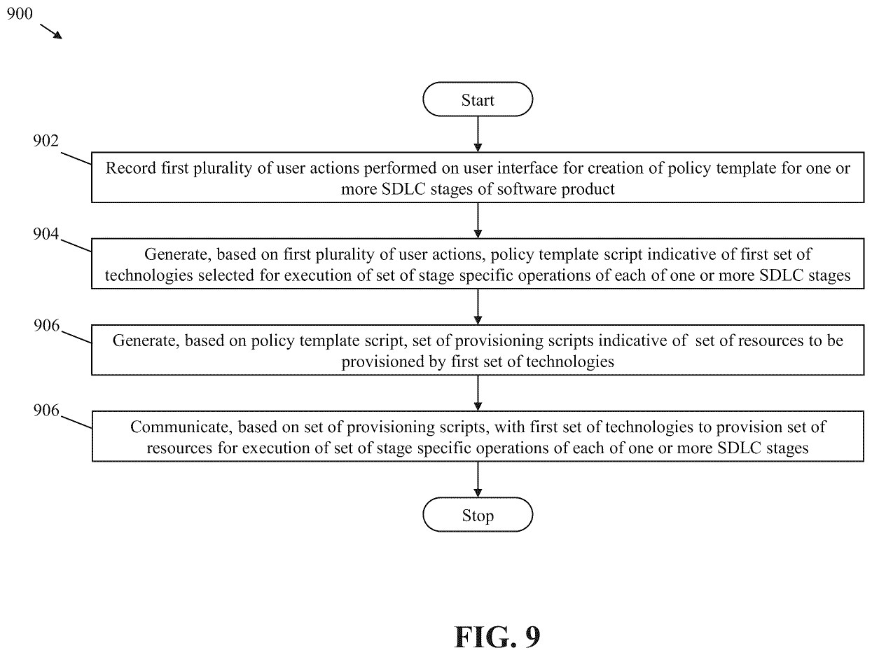

FIG. 8 is a block diagram that illustrates a system architecture of a computer system 800 for designing and enforcing a multi-cloud deployment policy for software application of the system environment of FIG. 1, in accordance with an exemplary embodiment of the disclosure. An embodiment of the disclosure, or portions thereof, may be implemented as computer-readable code on the computer system 800. In one example, the system of FIG. 1 may be implemented in the computer system 800 using hardware, software, firmware, a non-transitory computer-readable medium having instructions stored thereon, or a combination thereof, and may be implemented in one or more computer systems or other processing systems. Hardware, software, or any combination thereof may embody modules and components used to implement the method of FIG. 9.

The computer system 800 may include a processor 802 that may be a special-purpose or a general-purpose processing device. The processor 802 may be a single processor or multiple processors. The processor 802 may have one or more processor “cores.” Further, the processor 802 may be coupled to a communication infrastructure 804, such as a bus, a bridge, a message queue, the communication network 110, a multi-core message-passing scheme, or the like. The computer system 800 may further include a main memory 806 and a secondary memory 808. Examples of the main memory 806 may include RAM, ROM, and the like. The secondary memory 808 may include a hard disk drive or a removable storage drive (not shown), such as a floppy disk drive, a magnetic tape drive, a compact disc, an optical disk drive, a flash memory, or the like. Further, the removable storage drive may read from and/or write to a removable storage device in a manner known in the art. In an embodiment, the removable storage unit may be a non-transitory computer-readable recording medium.

The computer system 800 may further include an input/output (I/O) port 810 and a communication interface 812. The I/O port 810 may include various input and output devices that are configured to communicate with the processor 802. Examples of the input devices may include a keyboard, a mouse, a joystick, a touchscreen, a microphone, and the like. Examples of the output devices may include a display screen, a speaker, headphones, and the like. The communication interface 812 may be configured to allow data to be transferred between the computer system 800 and various devices that are communicatively coupled to the computer system 800. Examples of the communication interface 812 may include a modem, a network interface, i.e., an Ethernet card, a communication port, and the like. Data transferred via the communication interface 812 may be signals, such as electronic, electromagnetic, optical, or other signals as will be apparent to a person skilled in the art. The signals may travel via a communications channel, such as the communication infrastructure 804, which may be configured to transmit the signals to the various devices that are communicatively coupled to the computer system 800. Examples of the communication channel may include wired, wireless, and/or optical media such as cable, fiber optics, a phone line, a cellular phone link, a radio frequency link, and the like. The main memory 806 and the secondary memory 808 may refer to non-transitory computer-readable mediums that may provide data that enables the computer system 800 to implement the method illustrated in FIG. 9.

FIG. 9 is a flowchart 900 that illustrates a method for creation and enforcement of a policy template, in accordance with an embodiment of the present disclosure. Referring to FIG. 9, at 902, a first plurality of user actions, performed on a user interface (UI), may be recorded. The first plurality of user actions may be associated with creation of a policy template for one or more SDLC stages of a software product. The first plurality of user actions include selection of a first set of technologies of a plurality of technologies available for execution of a set of stage specific operations of the one or more SDLC stages. The first set of technologies is selected for execution of the set of stage specific operations of each of the one or more SDLC stages. The first plurality of user actions may be recorded by a policy template designer (for example, the policy template designer 502).

At 904, a policy template script (for example, the policy template script 520) may be generated based on the first plurality of user actions or metadata associated with the first plurality of user actions. The policy template script may be indicative of the first set of technologies selected for execution of the set of stage specific operations of each of the one or more SDLC stages. A script generator (for example, the script generator 518) may be configured to generate the policy template script.

At 906, a set of provisioning scripts may be generated based on the policy template script. The set of provisioning scripts may be indicative of a set of resources to be provisioned by the first set of technologies. A policy enforcement engine (for example, the policy enforcement engine 528) may be configured to generate the set of provisioning scripts.

At 908, a set of technology-specific interpreters may communicate, based on the set of provisioning scripts, with the first set of technologies to provision the set of resources for execution of the set of stage specific operations of each of the one or more SDLC stages of the software product.

A person of ordinary skill in the art will appreciate that embodiments and exemplary scenarios of the disclosed subject matter may be practiced with various computer system configurations, including multi-core multiprocessor systems, minicomputers, mainframe computers, computers linked or clustered with distributed functions, as well as pervasive or miniature computers that may be embedded into virtually any device. Further, the operations may be described as a sequential process, however, some of the operations may in fact be performed in parallel, concurrently, and/or in a distributed environment, and with program code stored locally or remotely for access by single or multiprocessor machines. In addition, in some embodiments, the order of operations may be rearranged without departing from the spirit of the disclosed subject matter.

The proposed architecture (the architecture 300) offers numerous advantages by addressing the limitations of traditional approaches to managing tools, technologies, and configurations across SDLC of a software product. The architecture 300 exhibits dynamic adaptability which ensures that selections of tools, technologies, microservices, or the like are always aligned with the most current organizational preferences, software requirements, and compliance policies, eliminating reliance on outdated static documentation. By incorporating generation of provisioning scripts that may be specific for each facet of the software product, the architecture 300 automates decision-making, reducing manual intervention and minimizing the likelihood of errors. This automation not only enhances efficiency but also accelerates workflows, enabling faster execution of lifecycle stages and improving overall productivity.

Furthermore, the architecture 300 provides a centralized platform for managing resources, fostering consistency and collaboration among teams. The architecture 300 further provides seamless integration with existing tools and technologies which ensures compatibility without disrupting current processes. Scalability and real-time updates allow the architecture 300 to grow with organizational needs and adapt to policy or regulatory changes, ensuring ongoing compliance. By reducing inefficiencies, errors, and manual effort, the architecture 300 also lowers operational costs while enabling organizations to tailor rules and constraints to their unique requirements. Hence, the architecture 300 provides a comprehensive and user-friendly solution that optimize workflows, reduce risks, and enhance the reliability and effectiveness of the software development lifecycle.

In the claims, the words ‘comprising’, ‘including’, and ‘having’ do not exclude the presence of other elements or steps than those listed in a claim. The terms “a” or “an,” as used herein, are defined as one or more than one. Unless stated otherwise, terms such as “first” and “second” are used to arbitrarily distinguish between the elements such terms describe. Thus, these terms are not necessarily intended to indicate temporal or other prioritization of such elements. The fact that certain measures are recited in mutually different claims does not indicate that a combination of these measures cannot be used to advantage.

While various exemplary embodiments of the disclosed system and method have been described above it should be understood that they have been presented for purposes of example only, not limitations. It is not exhaustive and does not limit the disclosure to the precise form disclosed. Numerous modifications, changes, variations, substitutions, and equivalents will be apparent to those skilled in the art, without departing from the spirit and scope of the present disclosure, as described.

What is claimed is:

1. A non-transitory computer-readable medium having stored therein, computer executable instructions, which when executed by a computer, implement an architecture for creation and enforcement of policy templates, the architecture comprising:
a policy template designer configured to:
record a first plurality of user actions performed on a user interface (UI) for creation of a policy template for one or more software development lifecycle (SDLC) stages of a software product, wherein the first plurality of user actions include selection of a first set of technologies of a plurality of technologies available for execution of a set of stage specific operations of the one or more SDLC stages, and wherein the first set of technologies is selected for execution of the set of stage specific operations of each of the one or more SDLC stages;
a script generator configured to generate, based on the first plurality of user actions, a policy template script indicative of the first set of technologies selected for execution of the set of stage specific operations of each of the one or more SDLC stages;
a plurality of technology-specific interpreters; and
a policy enforcement engine configured to:
generate, based on the policy template script, a set of provisioning scripts indicative of a set of resources to be provisioned by the first set of technologies; and
communicate the set of provisioning scripts to a first set of technology-specific interpreters of the plurality of technology-specific interpreters,
wherein the first set of technology-specific interpreters is configured to receive the set of provisioning scripts from the policy enforcement engine, and communicate, based on the received set of provisioning scripts, with the first set of technologies to provision the set of resources for execution of the set of stage specific operations of the one or more SDLC stages.

2. The non-transitory computer-readable medium of claim 1, wherein the policy template script comprises at least one of a group consisting of: an application topology subscript, a deployment standards subscript, a pipeline configuration subscript, a cloud environment subscript, or an access policy subscript.

3. The non-transitory computer-readable medium of claim 1, wherein the provisioning of the set of resources by each of the first set of technologies corresponds to the enforcement of the policy template script.

4. The non-transitory computer-readable medium of claim 1, wherein the policy template designer is further configured to:
render, on a user device, the UI for the creation and the enforcement of the policy templates, wherein the UI represents a plurality of SDLC stages of the software product; and
present, using the UI, the plurality of technologies, wherein the plurality of technologies are presented based on a selection of the one or more SDLC stages of the plurality of SDLC stages, and wherein the first plurality of user actions is recorded further based on the presented plurality of technologies.

5. The non-transitory computer-readable medium of claim 1, wherein the first set of technology-specific interpreters is further configured to:
convert the set of provisioning scripts into a set of technology-specific scripts that is in a format that is compatible with the first set of technologies; and
communicate the set of technology-specific scripts to the first set of technologies, wherein the first set of technologies receive the set of technology-specific scripts and provisions, based on the received set of technology-specific scripts, the set of resources.

6. The non-transitory computer-readable medium of claim 1,
wherein the architecture further comprising a plurality of gentech script generators,
wherein a set of gentech script generators of the plurality of gentech script generators is configured to generate, based on the policy template script, a set of gentech scripts for implementing the provisioning of the set of resources by the first set of technologies,
wherein the set of gentech script generators are compatible with the first set of technologies, and
wherein the first set of technology-specific interpreters communicate with the first set of technologies further based on the set of gentech scripts.

7. The non-transitory computer-readable medium of claim 1, wherein the one or more SDLC stages comprise at least one of a group consisting of a define stage, a design stage, a development stage, or a deployment stage.

8. The non-transitory computer-readable medium of claim 1, wherein the architecture further comprising a plurality of reverse interpreters, wherein a set of reverse interpreters of the plurality of reverse interpreters is configured to receive a set of feedback scripts from the first set of technologies, and wherein the script generator is further configured to generate an updated policy template script based on the set of feedback scripts.

9. The non-transitory computer-readable medium of claim 8,
wherein the policy enforcement engine is further configured to update the set of provisioning scripts based on the updated policy template script, and
wherein the first set of technology-specific interpreters is further configured to communicate with the first set of technologies further based on the updated set of provisioning scripts.

10. The non-transitory computer-readable medium of claim 8, wherein the set of feedback scripts is received based on an execution of the one or more SDLC stages.

11. The non-transitory computer-readable medium of claim 1, wherein the architecture further comprising a set of predefined policy template scripts with each predefined policy template script of the set of predefined policy template scripts being indicative of a corresponding second set of technologies for execution of the set of stage specific operations of the one or more SDLC stages.

12. The non-transitory computer-readable medium of claim 11,
wherein the policy enforcement engine is further configured to generate, based on at least one of the set of predefined policy template scripts, a predefined provisioning script, and
wherein a second set of technology-specific interpreters of the plurality of technology-specific interpreters are configured to communicate with the second set of technologies, based on the predefined provisioning script, to provision one or more resources based on the predefined provisioning script.

13. The non-transitory computer-readable medium of claim 1,
wherein the policy template designer is further configured to record a second plurality of user actions performed on the UI for modification of the policy template,
wherein the second plurality of user actions include selection of a second set of technologies of the plurality of technologies for execution of one or more stage specific operations of the set of stage specific operations of the one or more SDLC stages,
wherein the script generator is further configured to update, based on the second plurality of user actions, the policy template script to reflect the selection of the second set of technologies, and
wherein the policy enforcement engine is further configured to:
generate, based on the updated policy template script, a set of revised provisioning scripts that conform with the updated policy template script; and
communicate the set of revised provisioning scripts to a second set of technology-specific interpreters of the plurality of technology-specific interpreters, wherein the set of revised provisioning scripts is indicative of a change in the set of resources,
the second set of technology-specific interpreters configured to communicate, based on the set of revised provisioning scripts, with the second set of technologies to update the set of resources provisioned for execution of the set of stage specific operations.

14. The non-transitory computer-readable medium of claim 1, wherein the policy template script is generated further based on at least one of a group consisting of a set of application driven policies or a set of optimal policy practices.

15. The non-transitory computer-readable medium of claim 1, wherein the policy enforcement engine comprises a validation engine configured to:
execute, using the policy template script, one or more SDLC stages of a demo software product with a software configuration of the software product;
generate, based on the execution of the one or more SDLC stages of the demo software product, a set of updates for the policy template script; and
validate, based on the execution of the one or more SDLC stages of the demo software product, the policy template script, wherein the validation of the policy template script is indicative of the policy template being implementable using the first set of technologies.

16. The non-transitory computer-readable medium of claim 1, wherein the set of provisioning scripts includes at least one of a group consisting of: an environment policy script, an access provisioning script, or a pipeline orchestration script.

17. The non-transitory computer-readable medium of claim 16,
wherein the policy enforcement engine further comprises a cloud environment provisioning engine configured to generate the environment policy script, a user access provisioning engine configured to generate an access policy script, and a pipeline setup engine configured to generate a pipeline configuration script,
wherein the environment policy script includes a first set of instructions indicative of provisioning of a first subset of resources, of the set of resources, to be provisioned for creation of a cloud environment for the software product,
wherein the access policy script includes a second set of instructions indicative of provisioning of a second subset of resources, of the set of resources, to be provisioned for implementing access control policy associated with the software product,
wherein the pipeline orchestration script includes a third set of instructions indicative of a third subset of resources, of the set of resources, to be provisioned for creation of one or more pipeline stages associated with the software product, and
wherein the first subset of resources, the second subset of resources, and the third subset of resources, collectively, constitute the set of resources.

18. The non-transitory computer-readable medium of claim 17,
wherein the environment policy script is further indicative of a first subset of technologies of the first set of technologies selected for provisioning of the first subset of resources,
wherein the access policy script is further indicative of a second subset of technologies of the first set of technologies selected for provisioning of the second subset of resources,
wherein the pipeline orchestration script is further indicative of a third subset of technologies of the first set of technologies selected for provisioning of the third subset of resources, and
wherein the first subset of technologies, the second subset of technologies, and the third subset of technologies, collectively, constitute the first set of technologies.

19. The non-transitory computer-readable medium of claim 1, wherein the architecture further comprising a watcher configured to:
monitor the creation and enforcement of the policy template, wherein the provisioning of the set of resources corresponds to the enforcement of the policy template;
analyse the enforced policy template based on at least one of a group consisting of the provisioned set of resources or an execution of the set of stage specific operations of the one or more SDLC stages; and
generate a set of recommendations associated with the enforced policy template, wherein the set of recommendations is generated based on the set of provisioned resources being divergent from a set of required resources for the execution of the set of stage specific operations of the one or more SDLC stages of the software product.

20. A method for creating and enforcing policy templates, comprising:
recording a first plurality of user actions performed on a user interface (UI) for creation of a policy template for one or more SDLC stages of a software product, wherein the first plurality of user actions include selection of a first set of technologies of a plurality of technologies available for execution of a set of stage specific operations of the one or more SDLC stages, and wherein the first set of technologies is selected for execution of the set of stage specific operations of each of the one or more SDLC stages;
generating, based on the first plurality of user actions, a policy template script indicative of the first set of technologies selected for execution of the set of stage specific operations of each of the one or more SDLC stages;
generating, based on the policy template script, a set of provisioning scripts indicative of a set of resources to be provisioned by the first set of technologies; and
communicating, based on the set of provisioning scripts, with the first set of technologies to provision the set of resources for execution of the set of stage specific operations of each of the one or more SDLC stages.
